(19) United States
(12) Patent Application Publication
(10) Pub. No.: US 2006/0238653 A1
(43) Pub. Date: Oct. 26, 2006

(54) IMAGE PROCESSING APPARATUS, IMAGE PROCESSING METHOD, AND COMPUTER PROGRAM

(75) Inventor: Hiroaki Tobita, Tokyo (JP)

Correspondence Address: BELL, BOYD & LLOYD, LLC, P. O. BOX 1135, CHICAGO, IL, 60690-1135, US

(73) Assignee: Sony Corporation, Tokyo (JP)

(21) Appl. No.: 11/278,774

(22) Filed: Apr. 5, 2006

(30) Foreign Application Priority Data
Jun. 7, 2005 (JP) JP2005-167075
Apr. 7, 2005 (JP) JP2005-111318

(51) Int. Cl. H04N 9/74

(52) U.S. Cl. 348/581

(57) ABSTRACT

An image processing apparatus is provided. The image processing apparatus includes an extracting device configured to extract feature regions from image regions of original images constituted by at least one frame, and an image deforming device configured to deform the original images with regard to the feature regions so as to create feature-deformed images.

### CROSS REFERENCES TO RELATED APPLICATIONS

The present application claims priority to Japanese Patent Applications JP 2005-167075 and JP 2005-111318 filed with the Japanese Patent Office on Jun. 7, 2005 and Apr. 7, 2005 respectively, the entire contents of which being incorporated herein by reference.

### BACKGROUND

The present application relates to an image processing apparatus, an image processing method, and a computer program.

Today, along with progress in information technology has come the widespread acceptance of personal computers (PCs), digital cameras, and digital camera-equipped mobile phones by the general public. It has become common practice for people to make use of these devices in all kinds of situations.

Given such trends, huge quantities of digital image contents of still and moving images exist on the Internet and in users' devices. The images come in all types: digital or other images carried by websites, and still images taken by users typically on vacation.

There generally exist systems each designed to make efficient searches specifically for what is desired by users from such large amounts of contents. Where a particular still image is desired, the corresponding content is retrieved and its thumbnail is displayed by the user's system for eventual output onto a display device or printing medium such as photographic paper.

The above type of system allows the user to get an overview of any desired content based on a thumbnail display. With a plurality of thumbnails displayed for the viewer to check on a single screen, the user can grasp an outline of the corresponding multiple contents at a time.

Efforts have been made to develop ways to display as many thumbnails as possible at a time on a single screen or on a piece of printing medium. The emphasis is on how to scale down the thumbnail display per frame without detracting from conspicuity from the user's point of view.

One way to display thumbnails efficiently is by trimming unnecessary parts from digital or other images and leaving only their suitable regions (i.e., regions of interest or feature regions). A system that performs such trimming work automatically is disclosed illustratively in Japanese Patent Laid-open No. 2004-228994.

In the field of moving images or videos, there exist systems for creating a digest video based on the feature parts (i.e., video features) characterized by volumes or by tickers. The digest videos are prepared to make efficient searches for what is desired by the user from huge quantities of contents. One such system is disclosed illustratively in Japanese Patent Laid-open No. 2000-223062.

The trimming work, while making the feature regions of a given image conspicuous, tends to truncate so much of the remaining image that the lost information often makes it impossible for the user to recognize what is represented by the thumbnail in question.

The digest video is typically created by picking up and putting together fragmented scenes of high volumes (e.g., from the audience) or with tickers. With the remaining scenes discarded, viewers tend to have difficulty grasping an outline of the content in question.

More often than not, the portions other than a given feature scene provide an introduction to understanding what that feature is about. In that sense, the viewer is expected to better understand the content of the video by viewing what comes immediately before and after the feature scene.

### SUMMARY

The present application has been made in view of the above circumstances and provides an image processing apparatus, an image processing method, and a computer program renewed and improved so as to perform deforming processes on image portions representing feature regions of a given image without reducing the amount of the information constituting that image.

In view of the above circumstances, the present application also provides an image processing apparatus, an image processing method, and a computer program renewed and improved so as to change the reproduction speed for video portions other than the feature part of a given video in such a manner that the farther away from the feature part, the progressively higher the reproduction speed for the non-feature portions and that the closer to the feature part, the progressively lower the reproduction speed for the non-feature portions.

In carrying out the present invention and according to one embodiment thereof, there is provided an image processing method including the steps of: extracting feature regions from image regions of original images constituted by at least one frame; and deforming the original images with regard to the feature regions so as to create feature-deformed images.

According to the image processing method outlined above, feature regions are extracted from the image regions of original images. The original images are then deformed with regard to their feature regions, whereby feature-deformed images are created. The method allows the amount of the information constituting the feature-deformed images to remain the same as that of the information making up the original images. That means the feature-deformed images can transmit the same content of information as the original images.

The feature-deformed images mentioned above may be output on a single screen or on one sheet of printing medium.

Preferably, the image deforming step may deform original image portions corresponding to the image regions other than the feature regions in the image regions of the original images, and the image deforming step may further scale original image portions corresponding to the feature regions. This preferred method also allows the amount of the information constituting the feature-deformed images to remain the same as that of the information making up the original images. It follows that the feature-deformed images can transmit the same content of information as the original images. Because the image portions corresponding to the feature regions are scaled, the resulting feature-deformed images become more conspicuous when viewed by the user and present the user with more accurate information than ever. The amount of the information constituting the original images refers to the amount of the information transmitted by the original images when these images are displayed or presented on the screen or on printing medium.

Preferably, the scaling factor for use in scaling the original images may vary with sizes of the feature regions. The scaling process may preferably involve scaling up the images.

The image deforming step may preferably generate mesh data based on the original images and may deform the mesh data thus generated.

Preferably, the image processing method according to embodiments of the present invention may further include the step of, in keeping with sizes of the feature regions extracted from original images constituted by a plurality of frames, changing sizes of the frames of each of the original images; wherein the extracting step and the image deforming step may be carried out on the image regions of the original images following the change in the frame sizes of the original images.

The scaling factor for use in scaling the original images may preferably vary with sizes of the feature regions.

Preferably, the image processing method according to an embodiment may further include the steps of: inputting instructions from a user for automatically starting the extracting step and the image deforming step; and outputting the feature-deformed images after the starting instructions were input and the extracting process and the image deforming step have ended.

The feature regions above may preferably include either facial regions of an imaged object or character regions.

According to another embodiment, there is provided an image processing apparatus including: an extracting device configured to extract feature regions from image regions of original images constituted by at least one frame; and an image deforming device configured to deform the original images with regard to the feature regions so as to create feature-deformed images.

The image deforming device may preferably deform original image portions corresponding to the image regions other than the feature regions in the image regions of the original images, and the image deforming device may further scale original image portions corresponding to the feature regions.

Preferably, the scaling factor for use in scaling the original images may vary with sizes of the feature regions.

The image deforming device may preferably generate mesh data based on the original images, deform the portions of the mesh data which correspond to the image regions other than the feature regions in the image regions of the original images, and scale the portions of the mesh data which correspond to the feature regions.

Preferably, the image processing apparatus according to an embodiment may further include a size changing device configured to change, in keeping with sizes of the feature regions extracted from original images constituted by a plurality of frames, sizes of the frames of each of the original images.

The inventive image processing apparatus above may further include: an inputting device configured to input instructions from a user for starting the extracting device and the image deforming device; and an outputting device configured to output the feature-deformed images.

According to a further embodiment, there is provided a computer program for causing a computer to function as an image processing apparatus including: extracting means configured to extract feature regions from image regions of original images constituted by at least one frame; and image deforming means configured to deform the original images with regard to the feature regions so as to create feature-deformed images.

In the foregoing embodiment, the image deforming means may preferably deform original image portions corresponding to the image regions other than the feature regions in the image regions of the original images, the image deforming means further scaling original image portions corresponding to the feature regions.

According to another embodiment, there is provided an image processing apparatus for reproducing a video stream carrying a series of original images constituted by at least one frame. The image processing apparatus includes: extracting means configured to extract feature regions from image regions of the original images constituting the video stream; feature video specifying means configured to specify as a feature video the extracted feature regions from the video stream larger in size than a predetermined threshold; deforming means configured to deform the video stream based at least on parameters each representing a distance from the feature video to the frame of each of the original images, the deforming means further acquiring weighting values on the basis of the deformed video stream; and a reproduction speed calculating device configured to calculate a reproduction speed based on the weighting values acquired by the deforming device.

Preferably, the foregoing image processing apparatus according to the present invention may further include a reproducing device configured to reproduce the video stream in accordance with the reproduction speed acquired by the reproduction speed calculating device.

Preferably, the farther away from the feature video being reproduced at a reference velocity of the reproduction speed, the progressively higher the reproduction speed may become for stream portions other than the feature video.

The extracting device may preferably extract the feature regions from the image regions of the original images by finding differences between each of the original images and an average image generated from either part or all of the frames constituting the video stream.

Preferably, the average image may be created on the basis of levels of brightness and/or of color saturation of pixels in either part or all of the frames constituting the original images.

Preferably, the farther away from the feature video being reproduced at a reference volume, the progressively lower the volume may become for stream portions other than the feature video.

Preferably, the extracting device may extract as feature regions audio information representative of the frames constituting the video stream; and the feature video specifying device may specify as the feature video the frames which are extracted when found to have audio information exceeding a predetermined threshold of the audio information.

According to another embodiment, there is provided a reproducing method for reproducing a video stream carrying a series of original images constituted by at least one frame. The reproducing method includes the steps of: extracting feature regions from image regions of the original images constituting the video stream; specifying as a feature video the extracted feature regions larger in size than a predetermined threshold; deforming the video stream based at least on parameters each representing a distance from the feature video to the frame of each of the original images, the deforming device further acquiring weighting values on the basis of the deformed video stream; and calculating a reproduction speed based on the weighting values acquired in the deforming step.

According to another embodiment, there is provided a computer program for causing a computer to function as an image processing apparatus for reproducing a video stream carrying a series of original images constituted by at least one frame. The image processing apparatus includes: extracting means configured to extract feature regions from image regions of the original images constituting the video stream; feature video specifying means configured to specify as a feature video the extracted feature regions from the video stream larger in size than a predetermined threshold; deforming means configured to deform the video stream based at least on parameters each representing a distance from the feature video to the frame of each of the original images, the deforming means further acquiring weighting values on the basis of the deformed video stream; and reproduction speed calculating means configured to calculate a reproduction speed based on the weighting values acquired by the deforming step.

According to embodiments of the present invention, as outlined above, the amount of the information constituting the original images such as thumbnail images is kept unchanged while the feature regions drawing the user's attention in the image regions of the original images are scaled up or down. As a result, even if the original images are small and are displayed at a time, the user can visually recognize the images with ease thanks to the support for image search provided by the above described embodiments.

Also according to embodiments of the present invention, video portions close to a specific feature video made up of frames are reproduced at speeds close to normal reproduction speed; video portions farther away from the feature video are reproduced at speeds progressively higher than normal reproduction speed. This makes it possible for the user to view the whole video in a reduced time while the amount of the information making up the video is kept unchanged. Because the user can view the videos of interest carefully while skipping the rest, the user can search for desired videos in an appreciably shorter time than before.

Additional features and advantages are described herein, and will be apparent from, the following Detailed Description and the figures.

### BRIEF DESCRIPTION OF THE FIGURES

Further objects and advantages of the present invention will become apparent upon a reading of the following description and appended drawings in which:

FIG. 1 is an explanatory view giving an external view of an image processing apparatus practiced as a first embodiment;

FIG. 2 is a block diagram outlining a typical structure of the image processing apparatus as the first embodiment;

FIG. 3 is an explanatory view outlining a typical structure of a computer program for causing a computer to function as the image processing apparatus practiced as the first embodiment;

FIG. 4 is a flowchart outlining typical image processes performed by the first embodiment;

FIG. 5 is a flowchart of steps constituting a feature region extracting process performed by the first embodiment;

FIG. 6 is an explanatory view outlining an original image applicable to the first embodiment;

FIG. 7 is an explanatory view outlining a feature-extracted image applicable to the first embodiment;

FIG. 8 is a flowchart of steps constituting a feature region deforming process performed by the first embodiment;

FIG. 9 is an explanatory view outlining a typical structure of mesh data applicable to the first embodiment;

FIG. 10 is an explanatory view outlining a typical structure of a meshed feature-extracted image obtained by adding mesh data to an original image applicable to the first embodiment;

FIG. 11 is an explanatory view outlining a typical structure of meshed feature-deformed image applicable to the first embodiment;

FIG. 12 is an explanatory view outlining a typical structure of a feature-deformed image applicable to the first embodiment;

FIG. 13 is a flowchart outlining typical image processes performed by a second embodiment;

FIG. 14 is an explanatory view outlining a typical structure of an original image applicable to the second embodiment;

FIG. 15 is an explanatory view outlining a feature-extracted image applicable to the second embodiment;

FIG. 16 is an explanatory view outlining a feature-deformed image applicable to the second embodiment;

FIG. 17 is a flowchart of steps outlining typical image processes performed by a third embodiment;

FIG. 18 is an explanatory view outlining a typical structure of an original image applicable to the third embodiment;

FIG. 19 is an explanatory view outlining a typical structure of a feature-extracted image applicable to the third embodiment;

FIG. 20 is an explanatory view outlining a typical structure of a feature-deformed image applicable to the third embodiment;

FIG. 21 is an explanatory view outlining a typical structure of an original image group applicable to a fourth embodiment;

FIG. 22 is an explanatory view outlining a typical structure of a feature-deformed image group applicable to the fourth embodiment;

FIG. 23 is a flowchart of steps outlining typical image processes performed by a fifth embodiment;

FIGS. 24A and 24B are explanatory views showing how images are typically processed by the fifth embodiment;

FIGS. 25A and 25B are other explanatory views showing how images are typically processed by the fifth embodiment;

FIG. 26 is an explanatory view outlining a typical structure of a computer program for causing a computer to function as an image processing apparatus practiced as a sixth embodiment;

FIGS. 27A, 27B, and 27C are explanatory views outlining typical structures of images applicable to the sixth embodiment;

FIG. 28 is an explanatory view outlining a typical structure of an average image applicable to the sixth embodiment;

FIG. 29 is a flowchart of steps constituting an average image creating process performed by the sixth embodiment;

FIG. 30 is a flowchart of steps in which the sixth embodiment specifies a feature video based on audio information;

FIG. 31 is a flowchart of steps constituting a deforming process performed by the sixth embodiment; and

FIGS. 32A, 32B, 32C, and 32D are explanatory views showing how the sixth embodiment typically performs its deforming process.

### DETAILED DESCRIPTION

Preferred embodiments of the present invention will now be described with reference to the accompanying drawings. Throughout the drawings and the descriptions that follow, like or corresponding parts in terms of function and structure will be designated by like reference numerals, and their explanations will be omitted where redundant.

### FIRST EMBODIMENT

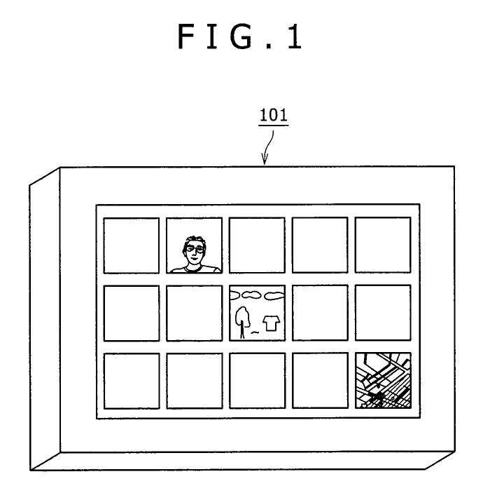

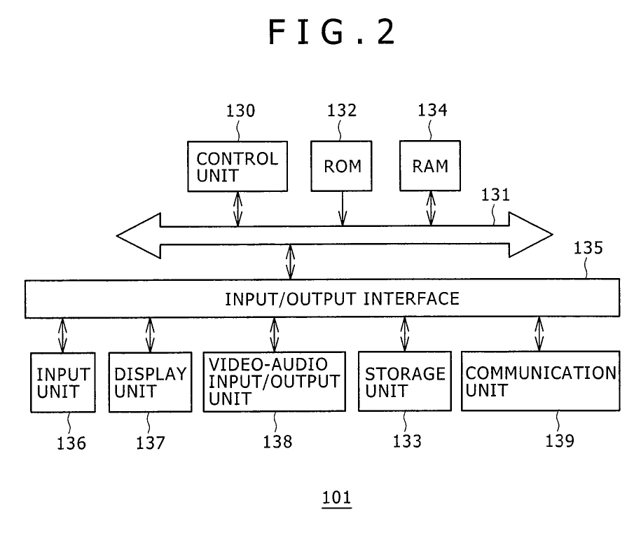

An image processing apparatus 101 practiced as the first embodiment will be described below by referring to FIGS. 1 and 2. FIG. 1 is an explanatory view giving an external view of the image processing apparatus 101 practiced as the first embodiment. FIG. 2 is a block diagram outlining a typical structure of the image processing apparatus 101 as the first embodiment.

As shown in FIG. 1, the image processing apparatus 101 is a highly mobile information processing apparatus equipped with a small display. It is assumed that the image processing apparatus 101 is capable of sending and receiving data over a network such as the Internet and of displaying one or a plurality of images. More specifically, the image processing apparatus 101 may be a mobile phone or a communication-capable digital camera but is not limited to such examples. Alternatively the image processing apparatus 101 may be a PDA (Personal Digital Assistant) or a laptop PC (Personal Computer).

Images that appear on the screen of the image processing apparatus 101 may be still images or movies. Videos composed typically of moving images will be discussed later in detail in conjunction with the sixth embodiment of the present invention.

The term “frame” used in connection with the first embodiment simply refers to what is delimited as the image region of an original image or the frame of the original image itself. In another context, the frame may refer to the image region of the original image and any image therein combined. These examples, however, are only for illustration purposes and will not limit how the frame is defined in this specification.

As shown in FIG. 1, a plurality of thumbnails (or, original images) are displayed on the screen of the image processing apparatus 101. The user of the apparatus moves a cursor over the thumbnails using illustratively arrow keys and positions the cursor eventually on a thumbnail of interest. Selecting the thumbnail causes the screen to display detailed information about the image represented by the selected thumbnail. Each original image is constituted illustratively by image data, and the image region of the original image is delimited illustratively by an original image frame.

Although the screen in FIG. 1 is shown furnished with a display region wide enough to display 15 frames (i.e., 3×5 frames) of original images, this is not limitative of the present invention. The display region may be of any size as long as it can display at least one frame of an original image.

Where the content involved is still images, the term “thumbnail” refers to an original still image such as a photo or to an image created by lowing the resolution of such an original still image. Where the content is movies or videos composed of moving images, the thumbnail refers to one frame of an original image at the beginning of a video or to an image created by lowering the resolution of that first image. In the description that follows, the images from which thumbnails are derived are generically called the original image.

The image processing apparatus 101 is thus characterized by its capability to assist the user in searching for what is desired from among huge amounts of information (or contents such as movies) that exist within the apparatus 101 or on the network, through the use of thumbnails displayed on the screen.

The image processing apparatus 101 embodying the present invention is not limited in capability to displaying still images; it is also capable of reproducing sounds and moving images. In that sense, the image processing apparatus 101 allows the user to reproduce such contents as sports and movies as well as to play video games.

As indicated in FIG. 2, the image processing apparatus 101 has a control unit 130, a bus 131, a storage unit 133, an input/output interface 135, an input unit 136, a display unit 137, a video-audio input/output unit 138, and a communication unit 139.

The control unit 130 controls processes of and instructions for the components making up the image processing apparatus 101. The control unit 130 also starts up and executes programs for performing a series of image processing steps such as those of extracting feature regions from the image region of each original image or deforming original images. Illustratively, the control unit 130 may be a CPU (Central Processing Unit) or an MPU (microprocessor) but is not limited thereto.

Programs and other resources held in a ROM (Read Only Memory) 132 or in the storage unit 133 are read out into a RAM (Random Access Memory) 134 through the bus 131 under control of the control unit 130. In accordance with the programs thus read out, the control unit 130 carries out diverse image processing steps.

The storage unit 133 is any storage device capable of letting the above-mentioned programs and such data as images be written and read thereto and therefrom. Specifically, the storage unit 133 may be a hard disk drive or an EEPROM (Electrically Erasable Programmable Read Only Memory) but is not limited thereto.

The input unit 136 is constituted illustratively by a pointing device such as one or a plurality of buttons, a trackball, a track pad, a stylus pen, a dial, and/or a joystick capable of receiving the user's instructions; or by a touch panel device for letting the user select any of the original images displayed on the display unit 137 through direct touches. These devices are cited here only for illustration purposes and thus will not limit the input unit 136 in any way.

The display unit 137 outputs at least texts regarding varieties of genres including literature, concerts, movies, and sports; sounds, moving images, still images, or any combination of these genres.

The bus 131 generically refers to a bus structure including an internal bus, a memory bus, and an I/O bus furnished inside the image processing apparatus 101. In operation, the bus 131 forwards data output by the diverse components of the apparatus to designated internal destinations.

Through a line connection, the video-audio input/output unit 138 accepts the input of data such as images and sounds reproduced by an external apparatus. The video-audio input/output unit 138 also outputs such data as images and sounds held in the storage unit 133 to an external apparatus through the line connection. The data accepted from the outside such as original images is output illustratively onto the display unit 137.

The communication unit 139 sends and receives diverse kinds of information over a wired or wireless network. Such a network is assumed to connect the image processing apparatus 101 with servers and other devices on the network in bidirectionally communicable fashion. Typically, the network is a public network such as the Internet; the network may also be a WAN, LAN, IP-VAN, or some other suitable closed circuit network. The communication medium for use with the communication unit 139 may be any one of a variety of media including optical fiber cables based on FDDI (Fiber Distributed Data Interface), coaxial or twisted pair cables compatible with the Ethernet™ (registered trademark), wireless connections according to IEEE802.11b, satellite communication links, or any other suitable wired or wireless communication media.

### Program for Causing the Image Processing Apparatus to Function

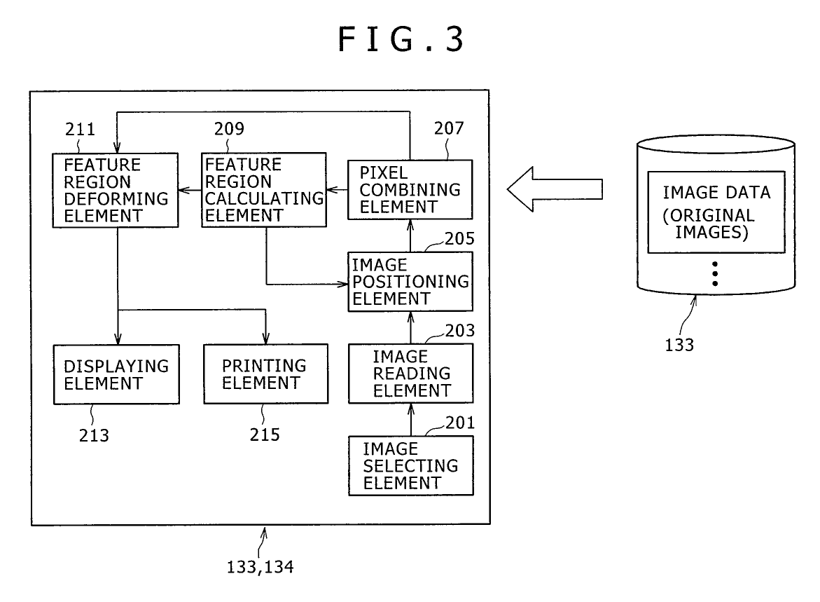

Described below with reference to FIG. 3 is a computer program that causes the image processing apparatus 101 to function as the first embodiment. What is indicated in FIG. 3 is an explanatory view showing a typical structure of the computer program in question.

The program for causing the image processing apparatus 101 to operate is typically preinstalled in the storage unit 133 in executable fashion. When the installed program is started in the image processing apparatus 101 preparatory to carrying out image processing such as a deforming process, the program is read into the RAM 134 for execution.

Although the computer program for implementing the first embodiment was shown to be preinstalled above, this is not limitative of the present invention. Alternatively, the computer program may be a program written in Java™ (registered trademark) or the like which is downloaded from a suitable server and interpreted.

As shown in FIG. 3, the program implementing the image processing apparatus 101 is made up of a plurality of modules. Specifically, the program includes an image selecting element 201, an image reading element 203, an image positioning element 205, a pixel combining element 207, a feature region calculating element (or extracting element) 209, a feature region deforming element (or image deforming element) 211, a displaying element 213, and a printing element 215.

The image selecting element 201 is a module which, upon receipt of instructions from the input unit 136 operated by the user, selects the image that matches the instructions or moves the cursor across the images displayed on the screen in order to select a desired image.

The image selecting element 201 is not functionally limited to receiving the user's instructions; it may also function to select images that are stored internally or images that exist on the network randomly or in reverse chronological order.

The image reading element 203 is a module that reads the images selected by the image selecting element 201 from the storage unit 133 or from servers or other sources on the network. The image reading element 203 is also capable of processing the images thus acquired into images at lower resolution (e.g., thumbnails) than their originals. In this specification, as explained above, original images also include thumbnails unless otherwise specified.

The image positioning element 205 is a module that positions original images where appropriate on the screen of the display unit 137. As described above, the screen displays one or a plurality of original images illustratively at predetermined space intervals. However, this image layout is not limitative of the functionality of the image positioning element 205.

The pixel combining element 207 is a module that combines the pixels of one or a plurality of original images to be displayed on the display unit 137 into data constituting a single display image over the entire screen. The display image data is the data that actually appears on the screen of the display unit 137.

The feature region calculating element 209 is a module that specifies eye-catching regions (region of interest, or feature region) in the image regions of original images.

After specifying a feature region in the image region of the original image, the feature region calculating element 209 processes the original image into a feature-extracted image in which the position of the feature region is delimited illustratively by a rectangle. The feature-extracted image, to be described later in more detail, is basically the same image as the original except that the specified feature region is shown extracted from within the original image.

Diverse feature regions may be specified in the original image by the feature region calculating element 209 of the first embodiment depending on what the original image contains. For example, if the original image contains a person and an animal, the feature region calculating element 209 may specify the face of the person or of the animal as a feature region; if the original image contains a legend of a map, the feature region calculating element 209 may specify that map legend as a feature region.

On specifying a feature region in the original image, the feature region calculating element 209 may generate mesh data that matches the original image so as to delimit the position of the feature region in a mesh structure. The mesh data will be discussed later in more detail.

After the feature region calculating element 209 specifies the feature region (i.e., region of interest), the feature region deforming element 211 performs a deforming process on both the specified feature region and the rest of the image region in the original image.

The feature region deforming element 211 of the first embodiment deforms the original image by carrying out the deforming process on the mesh data generated by the feature region calculating element 209. Because the image data making up the original image is not directly processed, the feature region deforming element 211 can perform its deforming process efficiently.

The displaying element 213 is a module that outputs to the display unit 137 the display image data containing the original images (including feature-deformed images) deformed by the feature region deforming element 211.

The printing element 215 is a module that prints onto printing medium the display image data including one or a plurality of original images (feature-deformed images) having undergone the deforming process performed by the feature region deforming element 211.

### Image Processing

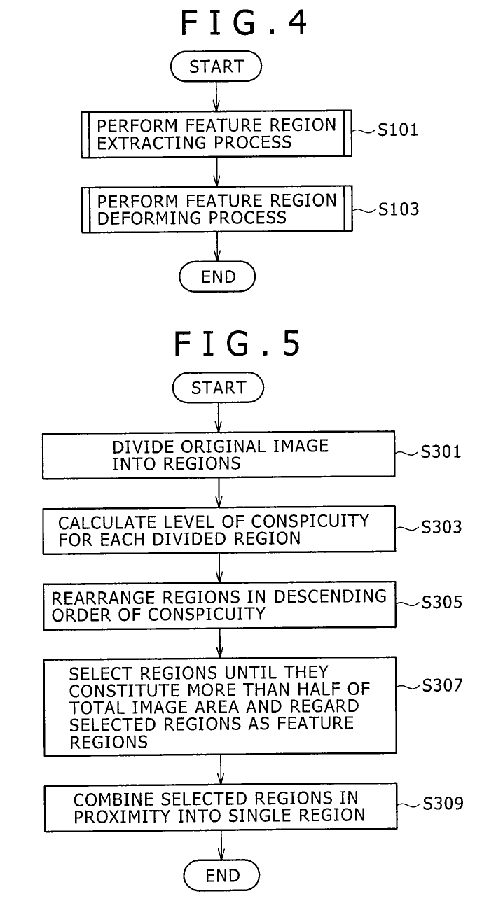

A series of image processes carried out by the first embodiment will now be described with reference to FIG. 4. FIG. 4 is a flowchart outlining typical image processes performed by the first embodiment.

As shown in FIG. 4, the image processing carried out on original images by the image processing apparatus 101 as the first embodiment is constituted by two major processes: feature region extracting process (S101), and feature region deforming process (S103).

In connection with the image processing of FIG. 4, if the original image read out illustratively by the image reading element 203 has a plurality of frames, then the feature region extracting process (S101) and feature region deforming process (S103) are carried out on the multiple-frame original image.

In this specification, the term “frame” refers to what demarcates the original image as its frame, what is delimited by the frame as the original image, or both.

The feature region extracting process (S101) mentioned above involves extracting feature regions such as eye-catching regions from the image region of a given original image. Described below in detail with reference to the relevant drawings is what the feature region extracting process (S101) does when executed.

### Feature Region Extracting Process

The feature region extracting process (S101) of this embodiment is described below by first referring to FIG. 5. FIG. 5 is a flowchart of steps outlining the feature region extracting process performed by the first embodiment.

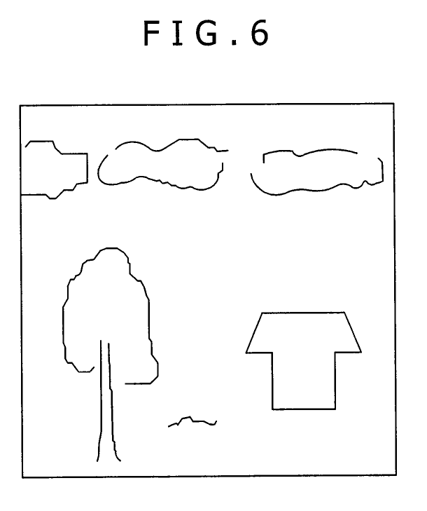

As shown in FIG. 5, the feature region calculating element 209 divides a read-out original image into regions (in step S301). Division of the original image into regions is briefly explained here by referring to FIG. 6. FIG. 6 is an explanatory view outlining an original image applicable to the first embodiment.

As depicted in FIG. 6, the original image illustratively includes a tree on the left-hand side of the image, a house on the right-hand side, and crowds in the upper part. The original image may be in bit-map format, in JPEG format, or in any other suitable format.

The original image shown in FIG. 6 is divided into regions by the feature region calculating element 209 (in step S301). Executing step S301 could involve dividing the original image into one or a plurality of blocks each defined by predetermined numbers of pixels in height and width.

The first embodiment, however, carries out image segmentation on the original image using the technique described by Nock, R., and Nielsen, F. in “Statistical Region Merging: Transactions on Pattern Analysis and Machine Intelligence (TPAMI)” (IEEE CS Press 4, pp. 557-560, 2004). However, this technique is only an example and not limitative of the present invention. Some other suitable technique may alternatively be used to carry out the image segmentation.

With the image divided into regions (in step S301), the feature region calculating element 209 calculates levels of conspicuity for each of the divided image regions for evaluation (in step S303). The level of conspicuity is a parameter for defining a subjectively perceived degree at which the region in question conceivably attracts people's attention. The level of conspicuity is thus a subjective parameter.

The divided image regions are evaluated for their levels of conspicuity. Generally, the most conspicuous region is extracted as the feature region. The evaluation is made subjectively in terms of a conspicuous physical feature appearing in each region. What is then extracted is the feature region that conforms to human subjectivity.

Illustratively, where the level of conspicuity is calculated, the region evaluated as having an elevated level of conspicuity may be a region of which the physical feature includes chromatic heterogeneity, or a region that has a color perceived subjectively as conspicuous (e.g., red) according to such chromatic factors as tint, saturation, and brightness.

With the first embodiment, the level of conspicuity is calculated and evaluated illustratively by use of the technique discussed by Shoji Tanaka, Seishi Inoue, Yuichi Iwatate, and Ryohei Nakatsu in “Conspicuity Evaluation Model Based on the Physical Feature in the Image Region (in Japanese)” (Proceedings of the Institute of Electronics, Information and Communication Engineers, A Vol. J83A No. 5, pp. 576-588, 2000). Alternatively, some other suitable techniques for dividing the image region may be utilized for calculation and evaluation purposes.

With the levels of conspicuity calculated and evaluated (in step S303), the feature region calculating element 209 rearranges the divided image regions in descending order of conspicuity in reference to the calculated levels of conspicuity for the regions involved (in step S305).

The feature region calculating element 209 then selects the divided image regions, one at a time, in descending order of conspicuity until the selected regions add up to more than half of the area of the original image. At this point, the feature region calculating element 209 stops the selection of divided image regions (in step S307).

The divided regions selected by the feature region calculating element 209 in step S307 are all regarded as the feature regions.

In step S309, the feature region calculating element 209 checks for any selected image region close to (e.g., contiguous with) the positions of the image regions selected in step S307. When any such selected image regions are found, the feature region calculating element 209 combines these image regions into a single image region (i.e., feature region).

In the foregoing description, the feature region calculating element 209 in step S307 was shown to regard the divided image regions selected by the element 209 as the feature regions. However, this is not limitative of the present invention. Alternatively, circumscribed quadrangles around all divided image regions selected by the feature region calculating element 209 may be regarded as feature regions.

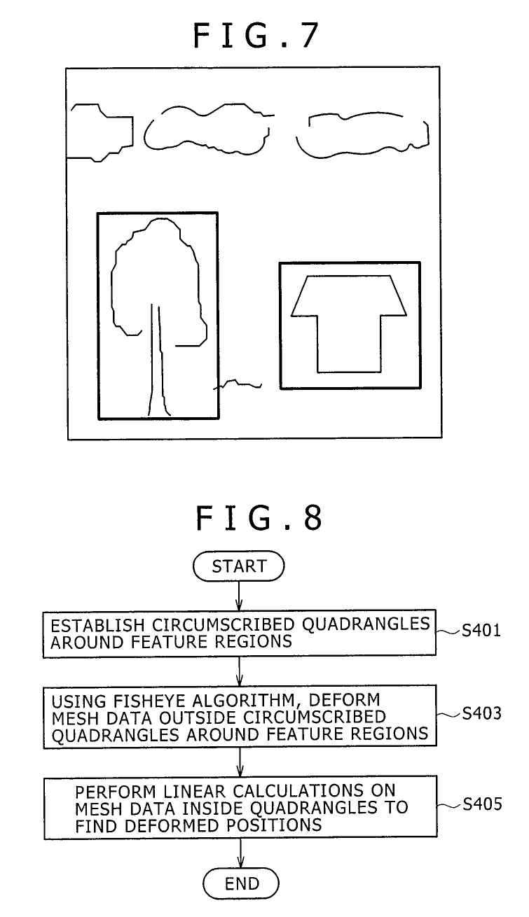

The feature region extracting process (S101) terminates after steps S301 through S309 above have been executed, whereby the feature regions are extracted from the image region of the original image. When the feature region extracting process (S101) is carried out illustratively on the original image of FIG. 6, a feature-extracted image whose feature regions are shown extracted in FIG. 7 is created.

As depicted in FIG. 7, the feature-extracted image indicates rectangles surrounding the tree and house expressed in the original image of FIG. 6. What is enclosed by the rectangles represents the feature regions. The feature regions in the feature-extracted image of FIG. 7 are the divided regions selected by the feature region calculating element 209 in step S307 and surrounded by a circumscribed quadrangle each. However, these are only examples and are not limitative of the invention.

Executing the feature region extracting process (S101) causes feature regions to be extracted. The positions of the extracted feature regions may be represented by coordinates of the vertexes on the rectangles such as those shown in FIG. 7, and the coordinates may be stored in the RAM 134 or storage unit 133 as feature region information.

### Feature Region Deforming Process

The feature region deforming process (S103) of the first embodiment is described below by referring to FIG. 8. FIG. 8 is a flowchart of steps constituting the feature region deforming process performed by the first embodiment.

As shown in FIG. 4, with the above-described feature region extracting process (S101) completed and with feature regions extracted from the original image, the feature region deforming process (S103) is carried out at least to deform the feature regions in a manner keeping the amount of information the same as that of the original image.

As outlined in FIG. 8, the feature region deforming element 211 establishes (in step S401) circumscribed quadrangles around the feature regions extracted from the image region of the original image by the feature region calculating element 209. This step is carried out on the basis of the feature region information stored in the RAM 134 or elsewhere. If the circumscribed quadrangles around the feature regions have already been established in the feature region extracting process (S101), step S401 maybe skipped.

The feature region deforming element 211 then deforms (i.e., performs its deforming process on) the mesh data corresponding to the regions outside the circumscribed quadrangles established in step S401 around the feature regions through the use of what is known as the fisheye algorithm (in step S403).

During the deforming process performed on the mesh data corresponding to the regions outside the circumscribed quadrangles around the feature regions, the degree of deformation is adjusted in keeping with the scaling factor for scaling up or down the feature regions.

### Mesh Data

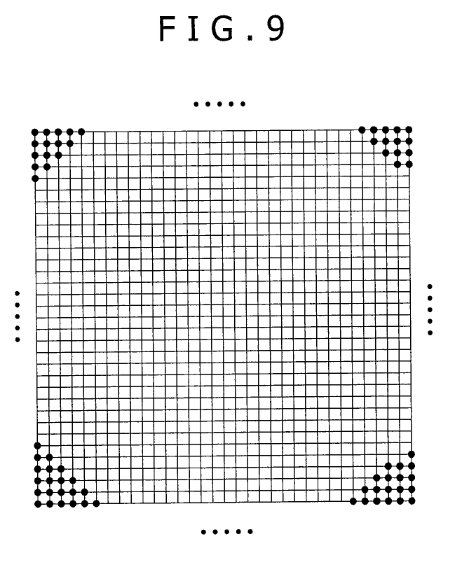

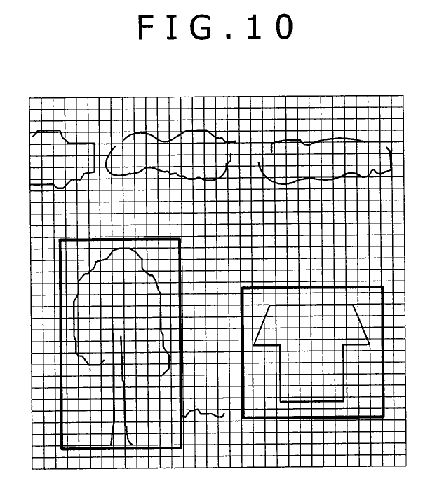

The mesh data applicable to the first embodiment is explained below by referring to FIGS. 9 and 10. FIG. 9 is an explanatory view outlining a typical structure of mesh data applicable to the first embodiment. FIG. 10 is an explanatory view outlining a typical structure of a meshed feature-extracted image obtained by adding mesh data to an original image applicable to the first embodiment.

As shown in FIG. 9, the mesh data constitutes a mesh-pattern structure made up of blocks (e.g., squares) having a predetermined area each. As illustrated, the coordinates of block vertexes (points “.” shown in FIG. 9) are structured into the mesh data in units of blocks.

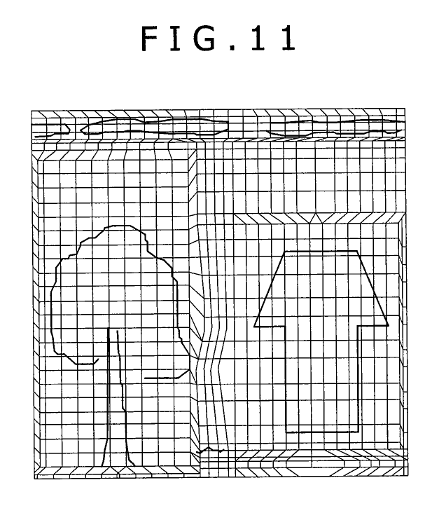

Although not all blocks in FIG. 9 are shown furnished with points, all blocks are assumed in practice to have the points representing their vertexes. The same applies to the mesh data shown in FIGS. 10 and 11.

The feature region deforming element 211 generates mesh data as shown in FIG. 9 in a manner matching the size of the read-out original image and, based on the mesh data thus generated, performs its deforming process as will be discussed below. Carrying out the deforming process in this manner makes deformation of the original image much more efficient or significantly less onerous than if the original image were processed in increments of pixels.

Basically, the number of points determined by the number of blocks constituting the mesh data for use by the first embodiment may be any desired number. The number of such usable points may vary depending on the throughput of the image processing apparatus 101.

FIG. 10 shows a meshed feature-extracted image acquired when the feature region deforming element 211 has generated mesh data and mapped it over the feature-extracted image. When any of the points shown in FIG. 10 are moved vertically and/or horizontally, the feature region deforming element 211 performs its deforming process in such a manner that those pixels or pixel groups in the feature-extracted image (original image) which correspond to the moved points are shifted in interlocked fashion. It should be noted that a pixel group in this context is a group of a plurality of pixels.

More specifically, as shown in FIG. 10, the deforming process is executed (in step S403) using the fisheye algorithm on the groups of points (“.”) included in the mesh data regions outside the feature regions (i.e., rectangles containing the tree and house in FIG. 10) in the image region of the original image.

Returning to FIG. 8, linear calculations are then made on the feature regions not deformed by the fisheye algorithm. The calculations are performed in interlocked relation to the outside of the feature regions having been moved following the deforming process in step S403, whereby the positions of the deformed feature regions are acquired (in step S405).

What takes place in step S405 above is that the deformed positions of the feature regions are obtained through linear calculations. The result is an enlarged representation of the feature regions through the scaling effect. A glance at the image thus deformed allows the user to notice its feature regions very easily.

Although step S405 performed by the first embodiment was described as scaling the inside of the feature regions through linear magnification, this is not limitative of the present invention. Alternatively, step S405 may be carried out linearly to scale down the inside of the feature regions or to scale it otherwise, i.e., without linear calculations.

The scaling factor for step S405 to be executed by the first embodiment in scaling up or down the feature region interior may be changed according to the size of the feature regions. For example, the scaling factor may be 2 for magnification or 0.5 for contraction when the feature region size is up to 100 pixels.

In step S405, as discussed above with reference to FIGS. 9 and 10, the deforming process is carried out on the mesh data constituted by the groups of points inside the feature regions of the image region in the original image.

After steps S403 and S405 have been executed by the feature region deforming element 211, the mesh data shown in FIG. 10 before deformation is transformed into deformed mesh data in FIG. 11.

FIG. 11 is an explanatory view outlining a typical structure of a meshed feature-deformed image applicable to the first embodiment. The image is acquired by supplementing the original image with the mesh data deformed by the first embodiment of the invention.

Following execution of steps S403 and S405 by the feature region deforming element 211, the mesh data is transformed into what is shown in FIG. 11.

When the mesh data constituted by the groups of points is moved by the mesh data deforming process, those pixel groups in the original image which correspond positionally to the moved point groups are shifted accordingly. This creates the feature-deformed image.

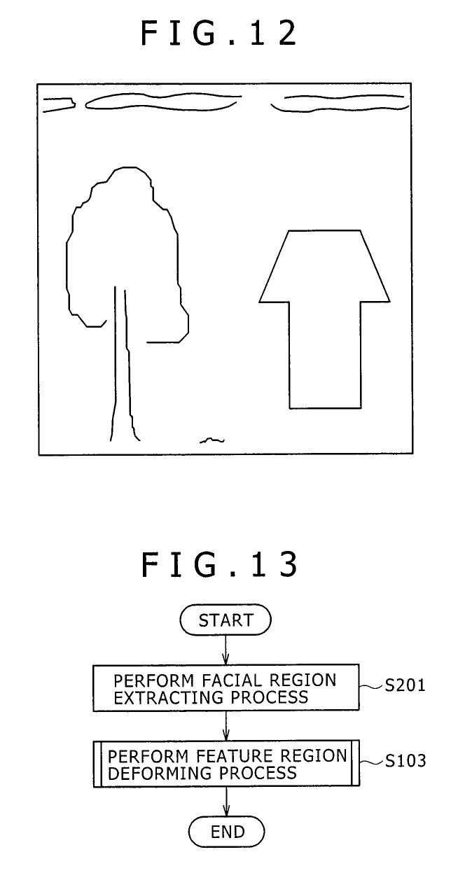

That is, as indicated in FIG. 11, when the mesh data is deformed (in steps S403 and S405), the crowds external to the feature regions in the original image are compressed in their representation toward the frame or toward the frame center. The crowds are thus shown deformed (compressed). The inside of the rectangles surrounding the tree and house (i.e., feature regions) is scaled up to make up for the compressed regions. The tree and house are thus expanded in their representation. The result is a feature-deformed image such as one indicated in FIG. 12.

When the feature region deforming element 211 carries out the feature region deforming process (S103) on the mesh data representing the original image, the original image is transformed as described into the feature-deformed image shown in FIG. 12.

Because the feature-deformed image always results from deformation of mesh data, reversing the deforming process on the mesh data turns the feature-deformed image back to the original image. However, this is not limitative. Alternatively, it is possible to create an irreversible feature-deformed image by directly deforming the original image. FIG. 12 is an explanatory view outlining a typical structure of such a feature-deformed image applicable to the first embodiment.

In the feature-deformed image, as shown in FIG. 12, the feature regions are expressed larger than in the original image; the rest of the image other than the feature regions is represented in a more deformed manner through the fisheye effect than in the original image. What is noticeable here is that the amount of the information constituting the original image is kept unchanged in both the feature regions and the rest of the image.

The amount of the information making up the original image is the quantity of information that is transmitted when the original image is displayed on the screen, printed on printing medium, or otherwise output and represented. The printing medium may be any one of diverse media including print-ready sheets of paper, peel-off stickers, and sheets of photographic paper. If the original image were simply trimmed and then enlarged, the amount of the information constituting the enlarged image is lower than that of the original image due to the absence of the truncated image portions. By contrast, the quantity of the information making up the feature-deformed image created by the first embodiment remains the same as that of the original image.

The specific fisheye algorithm used by the first embodiment of this invention is discussed illustratively by Furnas, G. W. in “Generalized Fisheye Views” (in Proceedings of the ACM Tran on Computer—Human Interaction, pp. 126-160, 1994). This algorithm, however, is only an example and is not limitative.

The foregoing has been the discussion of the series of processes carried out by the first embodiment of the invention. The image processing implemented by the first embodiment offers the following major benefits:

(1) The amount of the information constituting the feature-deformed image is the same as that of the original image. That means the feature-deformed image, when displayed or printed, transmits the same information as that of the original image. Because the feature-deformed image is represented in a manner effectively attracting the user's attention to the feature regions, the level of conspicuity of the image with regard to the user is improved and the information represented by the image is transmitted accurately to the user.

(2) Since the amount of the information constituting the feature-deformed image remains the same as that of the original image, the feature regions give the user the same kind of information (e.g., overview of content) as that transmitted by the original image. This makes it possible for the user to avoid recognizing the desired image erroneously. With the number of search attempts thus reduced, the user will appreciate efficient searching.

(3) In the feature-deformed image, the feature regions of the original image are scaled up. As a result, even when the feature-deformed image is reduced in size, the conspicuity of the image with regard to the user is not lowered. This makes it possible to increase the number of image frames that may be output onto the screen or on printing medium.

(4) The original image is processed on the basis of its mesh data. This feature significantly alleviates the processing burdens on the image processing apparatus 101 that is highly portable. The apparatus 101 can thus display feature-deformed images efficiently.

### SECOND EMBODIMENT

An image processing apparatus practiced as the second embodiment of the present invention will now be described. The paragraphs that follow will discuss in detail the major differences between the first and the second embodiments. The remaining features of the second embodiment are substantially the same as those of the first embodiment and thus will not be described further.

The image processing apparatus 101 as the first embodiment of the invention was discussed above with reference to FIGS. 1 through 3. The image processing apparatus 101 practiced as the second embodiment is basically the same as the first embodiment, except for what the feature region calculating element 209 does.

The feature region calculating element 209 of the second embodiment extracts feature regions from the image region of the original image in a manner different from the feature region calculating element 209 of the first embodiment. With the second embodiment, the feature region calculating element 209 carries out a facial region extracting process whereby a facial region is extracted from the image region of the original image. Extraction of the facial region as a feature region will be discussed later in detail.

Illustratively, the feature region calculating element 209 of the second embodiment recognizes a facial region in an original image representing objects having been imaged by digital camera or the like. Once the facial region is recognized, the feature region calculating element 209 extracts it from the image region of the original image.

In order to recognize the facial region appropriately or efficiently, the feature region calculating element 209 of the second embodiment may, where necessary, perform a color correcting process for correcting brightness or saturation of the original image during the facial region extracting process.

Furthermore, the storage unit 133 of the second embodiment differs from its counterpart of the first embodiment in that the second embodiment at least has a facial region extraction database retained in the storage unit 133. This database holds, among others, sample image data (or template data) about facial images by which to extract facial regions from the original image.

The sample image data is illustratively constituted by data representing facial images each generated from an average face derived from a plurality of people's faces. If a commonly perceived facial image is contained in the original image, that part of the original image is recognized as a facial image, and the region covering the facial image is extracted as a facial region.

Although the sample image data used by the second embodiment was shown representative of human faces, this is not limitative of the present invention. Alternatively, regions containing animals such as dogs and cats, as well as regions including material goods such as vehicles may be recognized and extracted using the sample image data.

### Image Processing

A series of image processes performed by the second embodiment will now be described by referring to FIG. 13. The paragraphs that follow will discuss in detail the major differences in terms of image processing between the first and the second embodiments. The remaining aspects of the processing are substantially the same between the two embodiments and thus will not be described further.

As shown in FIG. 13, a major difference in image processing between the first and the second embodiments is that the second embodiment involves carrying out a facial region extracting process (S201), which was not dealt with by the first embodiment explained above with reference to FIG. 4.

### Facial Region Extracting Process

The facial region extracting process indicated in FIG. 13 and carried out by the second embodiment is described below. This particular process (S201) is only an example; any other suitable process may be adopted as long as it can extract the facial region from the original image.

The facial region extracting process (S201) involves resizing the image region of the original image and extracting it in increments of blocks each having a predetermined area. More specifically, the resizing of an original image involves reading the original image of interest from the storage unit 133 and converting the retrieved image into a plurality of scaled images each having a different scaling factor.

For example, an original image applicable to the second embodiment is converted into five scaled images with five scaling factors of 1.0, 0.8, 0.64, 0.51, and 0.41. That is, the original image is reduced in size progressively by a factor of 0.8 in such a manner that the first scaled image is given the scaling factor of 1.0 and that the second through the fifth scaled images are assigned the progressively diminishing scaling factors of 0.8 through 0.41 respectively.

Each of the multiple scaled images thus generated is subjected to a segmenting process. First to be segmented is the first scaled image, scanned in increments of 2 pixels or other suitable units starting from the top left corner of the image. The scanning moves rightward and downward until the bottom right corner is reached. In this manner, square regions each having 20×20 pixels (called window images) are segmented successively. The starting point of the scanning of scaled image data is not limited to the top left comer of the scaled image; the scanning may also be started from, say, the top right corner of the image.

Each of the plurality of window images thus segmented from the first scaled image is subjected to a template matching process. The template matching process involves carrying out such operations as normalized correlation and error square on each of the window images segmented from the scaled image, so as to convert the image into a functional curve having a peak value. A threshold value low enough to minimize any decrease in recognition performance is then established for the functional curve. That threshold value is used as the basis for determining whether the window image in question is a facial image.

Preparatory to the template matching process above, sample image data (or template data) is placed into the facial region extraction database of the storage unit 133 as mentioned above. The sample image data representative of the image of an average human face is acquired illustratively by averaging the facial images of, say, 100 people.

Whether or not a given window image is a facial image is determined on the basis of the sample image data above. That decision is made by simply matching the window image data against threshold values derived from the sample image data as criteria for determining whether the window image of interest is a facial image.

If any of the segmented window images is determined as facial image data, that window image is regarded as a score image (i.e., window image found to be a facial image), and subsequent preprocessing is carried out.

If any window image is not found to be a facial image, then the subsequent preprocessing, pattern recognition and other processes will not be performed. The score image above may contain confidence information indicating how much certain the image in question is regarded as a facial region. Illustratively, the confidence information may vary numerically between “00” and “99.” The larger the value, the more certain the image as a facial region.

The time required to perform the above-explained operations of normalized correlation and error square is as little as one-tenth to one-hundredth of the time required for the subsequent preprocessing and pattern recognition (e.g., SVM (Support Vector Machine) recognition). During the template matching process, the window images constituting a facial image can be detected illustratively with a probability of at least 80 percent.

The preprocessing to be carried out downstream involves illustratively extracting 360 pixels from the score image of 20 by 20 pixels by curtailing from the image its four corners typically belonging to the background and irrelevant to the human face. The extraction is made illustratively through the use of a mask formed by a square minus its four corners. Although the second embodiment involves extracting 360 pixels from the 20-by-20 pixel score image by cutting off the four corners of the image, this is not limitative of the present invention. Alternatively, the four corners may be left intact.

The preprocessing further involves correcting the shades of gray in the extracted 360-pixel score image or its equivalent by use of such algorithms as RMS (Root Mean Square). The correction is made here in order to eliminate any gradient condition of the imaged object expressed in shades of gray, the condition being typically attributable to lighting during imaging.

The preprocessing may also involve transforming the score image into a group of vectors which in turn are converted to a single pattern vector illustratively through Gabor filtering. The type of filters for use in Gabor filtering may be changed as needed.

The subsequent pattern recognizing process extracts an image region (facial region) representative of the facial image from the score image acquired as the pattern vector through the above-described preprocessing.

Information about the facial regions extracted by the pattern recognizing process from the image region of the original image is stored into the RAM 134 or elsewhere. The information about the facial regions (i.e., facial region attribute information) illustratively includes the positions of the facial regions (in coordinates), area of each facial region (in numbers of pixels in the horizontal and vertical directions), and confidence information indicative of how much certain each region is regarded as a facial region.

As described, the first scaled image data is segmented in scanning fashion into window images which in turn are subjected to the subsequent template matching process, preprocessing, and pattern recognizing process. All this makes it possible to detect a plurality of score images each containing a facial region from the first scaled image. The processes substantially the same as those discussed above with regard to the first scaled image are also carried out on the second through the fifth scaled images.

After the facial image attribute information about one or a plurality of facial images is stored in the RAM 134 or elsewhere, the feature region calculating element 209 recognizes one or a plurality of facial regions from the image region of the original image. The feature region calculating element 209 extracts the recognized facial regions as feature regions from the image region of the original image.

As needed, the feature region calculating element 209 may establish a circumscribed quadrangle around extracted facial regions and consider that region thus delineated to be a facial region constituting a feature region. At this stage, the facial region extracting process is completed.

Although the facial region extracting process of the second embodiment was shown to extract facial regions using a matching method using sample image data, this is not limitative of the invention. Alternatively, any other method may be utilized as long as it can extract facial regions from the image of interest.

Upon completion of the facial region extracting process (S201) above, the feature region deforming element 211 carries out the feature region deforming process (S103). This feature region deforming process is substantially the same as that executed by the first embodiment and thus will now be described further in detail.

(Feature-extracted image and feature-deformed image following facial region extraction)

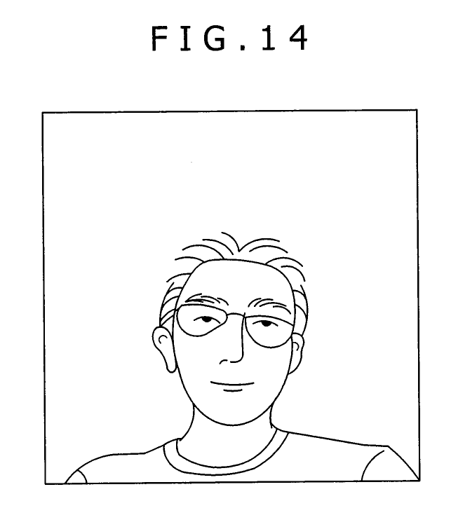

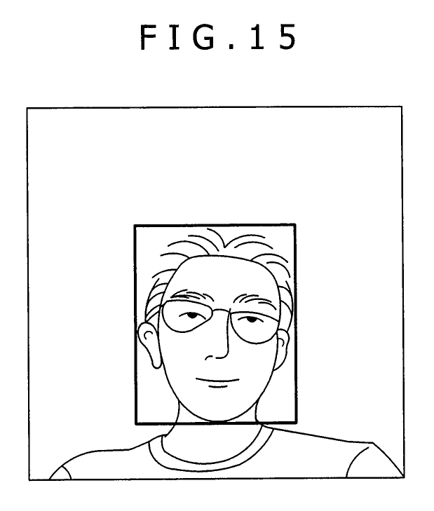

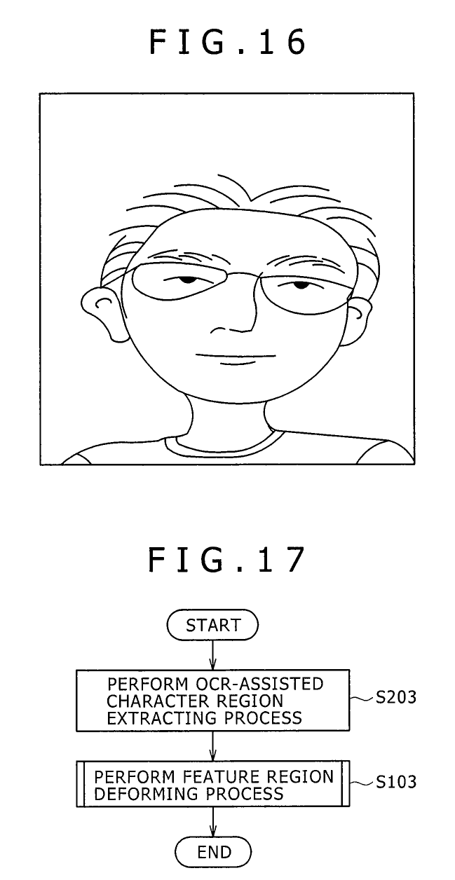

Described below with reference to FIGS. 14, 15, and 16 are a feature-extracted image and a feature-deformed image acquired by the second embodiment. FIG. 14 is an explanatory view outlining a typical structure of an original image applicable to the second embodiment. FIG. 15 is an explanatory view outlining a typical feature-extracted image applicable to the second embodiment, and FIG. 16 is an explanatory view outlining a typical feature-deformed image applicable to the second embodiment.

An original image such as one shown in FIG. 14, taken of a person by imaging equipment such as a digital camera, is stored into the storage unit 133 or elsewhere. Although the original image of FIG. 14 is seen depicting one person, this is not limitative of the invention. Alternatively, a plurality of persons may be represented in the original image. The resolution of the original image applicable to the second embodiment, while generally dependent on the performance of the imaging equipment, may be set for any value.

When the facial region extracting process (S201) is carried out by the second embodiment on the original image of FIG. 14, a facial region is extracted from the image region of the original image as shown in FIG. 15. Following the facial region extraction, the image carrying the extracted facial region is regarded as a feature-extracted image. In the feature-extracted image of FIG. 15, a rectangular frame delimits the facial region (i.e., feature region).

After the facial region is extracted as shown in the feature-extracted image of FIG. 15, the regions outside the facial region in the image region of the original image are subjected to the above-described deforming process based on the fisheye algorithm. The facial region is scaled up in such a manner that the original image shown in FIG. 14 is deformed into a feature-deformed image of FIG. 16.

In the series of image processes carried out by the second embodiment, the facial region extracting process (S201) and feature region deforming process (S103) are performed on the basis of mesh data as in the case of the above-described first embodiment.

### THIRD EMBODIMENT

An image processing apparatus practiced as the third embodiment will now be described. The paragraphs that follow will discuss in detail the major differences between the first and the third embodiments. The remaining features of the third embodiment are substantially the same as those of the first embodiment and thus will not be described further.

The image processing apparatus 101 as the first embodiment was discussed above with reference to FIGS. 1 through 3. The image processing apparatus 101 practiced as the third embodiment is basically the same as the first embodiment, except for what is carried out by the feature region calculating element 209.

The feature region calculating element 209 of the third embodiment extracts feature regions from the image region of the original image in a manner different from the feature region calculating element 209 of the first embodiment. With the third embodiment, the feature region calculating element 209 performs a character region extracting process whereby a region of characters is extracted from the image region of the original image. Extraction of the character region as a feature region will be discussed later in detail.

Illustratively, the feature region calculating element 209 of the third embodiment recognizes characters in an original image generated illustratively by digital camera or like equipment imaging or scanning a map. Once the character region is recognized, the feature region calculating element 209 extracts it from the image region of the original image.

In order to recognize characters appropriately or efficiently, the feature region calculating element 209 of the third embodiment may, where necessary, perform a color correcting process for correcting brightness or saturation of the original image during the character region extracting process.

More specifically, the feature region calculating element 209 of the third embodiment may use an OCR (Optical Character Reader) to recognize a character portion in the original image and extract that portion as a character region from the image region of the original image.

Although the feature region calculating element 209 of the third embodiment was shown to utilize the OCR for recognizing characters, this should not be considered limiting. Alternatively, any other suitable device may be adopted as long as it can recognize characters.

Furthermore, the storage unit 133 of the third embodiment differs from its counterpart of the first embodiment in that the third embodiment at least has a character region extraction database retained in the storage unit 133. This database holds, among others, pattern data about standard character images by which to extract characters from the original image.

Although the pattern data applicable to the third embodiment was shown to be characters, this is only an example and not limitative of the invention. The pattern data may also cover figures, symbols and others.

### Image Processing

A series of image processes performed by the third embodiment will now be described by referring to FIG. 17. The paragraphs that follow will discuss in detail the major differences in terms of image processing between the first and the third embodiments. The remaining aspects of the processing are substantially the same between the two embodiments and thus will not be described further.

As shown in FIG. 17, a major difference in image processing between the first and the third embodiments is that the third embodiment involves carrying out an OCR-assisted character region extracting process (S203), which was not dealt with by the first embodiment explained above with reference to FIG. 4.

### Character Region Extracting Process

What follows is a brief description of the character region extracting process indicated in FIG. 17 and carried out by the third embodiment. This OCR-assisted character region extracting process (S203) is only an example; any other suitable process may be adopted as long as it can extract the character region from the original image.

In operation, the feature region calculating element 209 uses illustratively an OCR to find out whether the image region of the original image contains any characters. If characters are detected, the feature region calculating element 209 recognizes the characters and extracts them as a character region from the image region of the original image.

The OCR is a common character recognition technique. As with ordinary pattern recognition systems, the OCR prepares beforehand the patterns of characters to be recognized as standard patterns (or pattern data). The OCR acts on a pattern matching method whereby the standard patterns are compared with an input pattern from the original image so that the closest of the standard patterns to the input pattern is selected as an outcome of character recognition. However, this technique is only an example and should not be considered limiting.

As needed, the feature region calculating element 209 may establish a circumscribed quadrangle around an extracted character region and consider the region thus delineated to be a character region constituting a feature region.

As shown in FIG. 17, upon completion of the character region extracting process (S203), the feature region deforming element 211 carries out the feature region deforming process (S103) on the extracted character region so as to deform the original image into a feature-deformed image. The feature region deforming process (S103) of the third embodiment is substantially the same as that of the above-described first embodiment and thus will not be described further.

### Feature-Extracted Image and Feature-Deformed Image Following Character Region Extraction

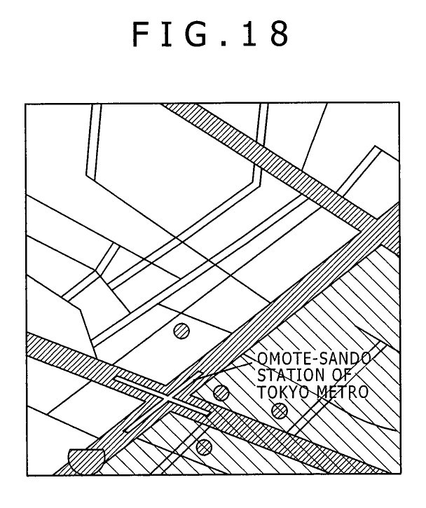

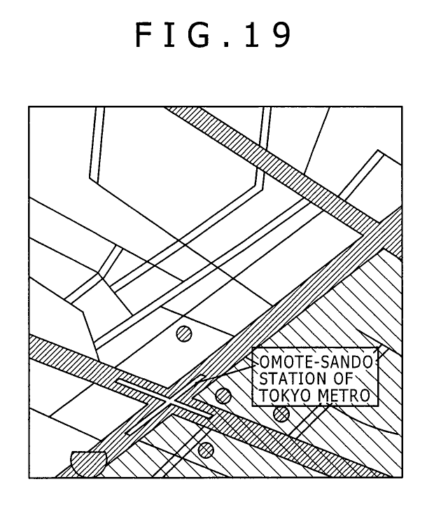

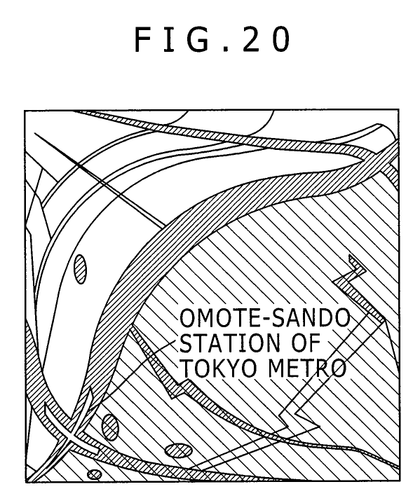

Described below with reference to FIGS. 18, 19, and 20 are a feature-extracted image and a feature-deformed image acquired by the third embodiment of the present invention. FIG. 18 is an explanatory view outlining a typical structure of an original image applicable to the third embodiment. FIG. 19 is an explanatory view outlining a typical feature-extracted image applicable to the third embodiment, and FIG. 20 is an explanatory view outlining a typical feature-deformed image applicable to the third embodiment.

An original image such as one shown in FIG. 18, generated by scanning of a map or the like, is stored into the storage unit 133 or elsewhere. The resolution of the original image applicable to the third embodiment, while generally dependent on the performance of scanning equipment, may be set for any value.

In the original image of FIG. 18, two lines of characters “TOKYO METRO, OMOTE-SANDO STATION” are seen inscribed. These characters are read by the OCR or like equipment for extraction as a character region.

The character region extracting process (S203) of the third embodiment is then carried out on the original image of FIG. 18. The process extracts a character region from the image region of the original image, as indicated in FIG. 19.

Following the character region extraction, the image additionally representing the extracted character region is regarded as a feature-extracted image. In the feature-extracted image of FIG. 19, the character region (i.e., feature region) is located within a rectangular frame structure. That is, the character region of FIG. 19 is found inside the rectangle delimiting the characters “TOKYO METRO, OMOTE-SANDO STATION.”

After the character region is extracted as shown in the feature-extracted image of FIG. 19, the regions outside the character region in the image region of the original image are subjected to the above-described deforming process based on the fisheye algorithm. The character region is scaled up in such a manner that the original image shown in FIG. 18 is deformed into a feature-deformed image indicated in FIG. 20.

In the series of image processes carried out by the third embodiment, the character region extracting process (S203) and feature region deforming process (S103) are performed on the basis of mesh data as in the case of the above-described first embodiment.

### FOURTH EMBODIMENT

An image processing apparatus practiced as the fourth embodiment will now be described. The paragraphs that follow will discuss in detail the major differences in terms of image processing between the first and the fourth embodiments. The remaining features of the fourth embodiment are substantially the same as those of the first embodiment and thus will not be described further.

In addition, the image processing apparatus of the fourth embodiment is substantially the same in structure as that of the above-described first embodiment and thus will not be discussed further.

### Image Processing

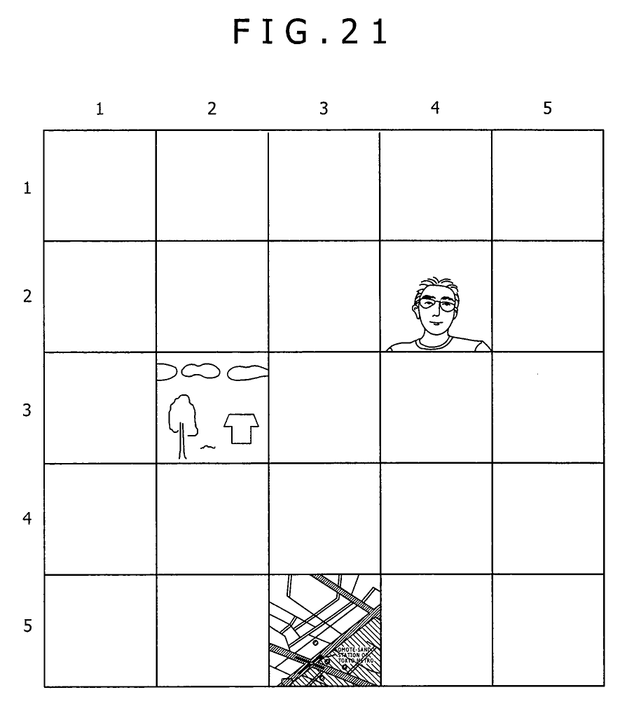

In the above-described series of image processes performed by the first through the third embodiments of the invention, it was the original image in one frame retrieved from the storage unit 133 that was shown to be dealt with. The fourth embodiment, by contrast, handles a group of original images in a plurality of frames retrieved from the storage unit 133 as shown in FIG. 21.

As depicted in FIG. 21, an original image group is formed by multiple original images in a plurality of frames retrieved by the pixel combining element 207 from the storage unit 133. The original image group is displayed illustratively on the screen as display image data.

In FIG. 21, frame positions are numbered starting from 1 followed by 2, 3, etc. (in the vertical and horizontal directions). The positions are indicated hypothetically in (x, y) coordinates in the figure. In practice, these numbers do not appear on the display unit 137.

As illustrated, the original image group in FIG. 21 is constituted by the following original images (or display images): an original image of a person shown in frame (2, 4), an original image of a tree and a house in frame (3, 2), and an original image of a map in frame (5, 3).

In FIG. 21, the original image group applicable to the fourth embodiment is shown made up of original images in three frames, with the remaining frames devoid of any original images. However, this is only an example and is not limitative of the invention. Alternatively, original images in any number of frames may be used as long as these images are in at least one frame and not in excess of the frames constituting each original image group.

In processing the original image group in FIG. 21, the fourth embodiment initially performs the feature region extracting process (S101), facial region extracting process (S201), or character region extracting process (S203) on each of the frames making up the image group starting from frame (1,1) in the top left corner. The fourth embodiment then carries out the feature region deforming process (S103).

During the image processing of the fourth embodiment, the facial region extracting process (S201) is carried out first on the original image in a given frame. If no facial region is detected in the image region of the original image in the frame of interest, then the character region extracting process (S203) is performed on the original image of the same frame. If no character region is found in the image region of the original image in the frame in question, then the feature region extracting process (S101) is executed on the original image of the same frame.

That is, the image processing of the fourth embodiment involves carrying out the facial region extracting process (S201), character region extracting process (S203), and feature region extracting process (S101), in that order, on the original image in the same frame. However, this sequence of processes is only an example; the processes may be executed in any other sequence.

The extracting processes (S101, S201, and S203) are also carried out on every original image containing a plurality of feature regions such as facial and character regions. This makes it possible to extract all feature regions from the original images that may be given.

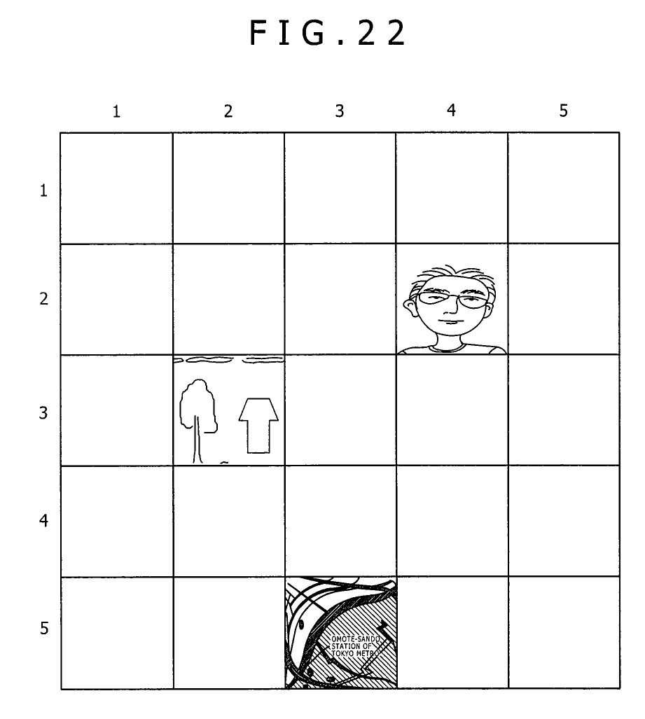

When the feature region extracting process (S101) and feature region deforming process (S103) are performed on the original image group in FIG. 21, the original image group of FIG. 21 is deformed into a feature-deformed image group shown in FIG. 22. In this feature-deformed image group, each of the frames has undergone the above-described series of processes.

In the series of image processes carried out by the fourth embodiment, the feature region deforming process (S103) and other processes are performed on the basis of mesh data as in the case of the above-described first embodiment.

The foregoing has been the discussion of the series of processes carried out by the fourth embodiment. The image processing implemented by the fourth embodiment offers the following major benefits:
(1) The image processing apparatus 101 displays on its screen a plurality of feature-deformed images. This allows the user to recognize multiple feature-deformed images at a time.
(2) The amount of the information constituting each feature-deformed image is the same as that of the corresponding original image. Those feature regions in the image which can attract the user's attention with a high probability are scaled up when displayed. That means the image processing apparatus 101 can display or print out a plurality of feature-deformed images at a time with their feature regions reduced in size without lowering the conspicuity of the output images with regard to the user. The image processing apparatus 101 thus helps the user avoid recognizing the desired image erroneously while making searches through images. As a result, the image processing apparatus 101 can boost the amount of information to be displayed or printed out simultaneously by increasing the number of frames in which to output original images on the screen or on printing medium.
(3) The amount of the information constituting the feature-deformed image in each frame remains the same as that of the corresponding original image, with the feature regions shown enlarged. This enables the image processing apparatus 101 to give the user the same kind of information (e.g., overview of content) as that transmitted by the original image. The enhanced conspicuity of the output images with regard to the user minimizes erroneous recognition of a target image.

### FIFTH EMBODIMENT

An image processing apparatus practiced as the fifth embodiment will now be described. The paragraphs that follow will discuss in detail the major differences between the first and the fifth embodiments. The remaining features of the fifth embodiment are substantially the same as those of the first embodiment and thus will not be described further.

The image processing apparatus 101 as the first embodiment of the invention was discussed above with reference to FIGS. 1 through 3. The image processing apparatus 101 practiced as the fifth embodiment is basically the same as the first embodiment except for what is performed by the image positioning element 205 and feature region calculating element 209.

The feature region calculating element 209 of the fifth embodiment outputs to the image positioning element 205 the sizes of the feature regions extracted from the image region of the original image. On receiving the feature region sizes, the image positioning element 205 scales up or down the area of the frame in question accordingly.

It should be noted that the feature region calculating element 209 of the fifth embodiment may selectively carry out the feature region extracting process (S101), facial region extracting process (S201), or character region extracting process (S203) described above. The processing thus performed is substantially the same as that carried out by the feature region calculating element 209 of the fourth embodiment.

### Image Processing

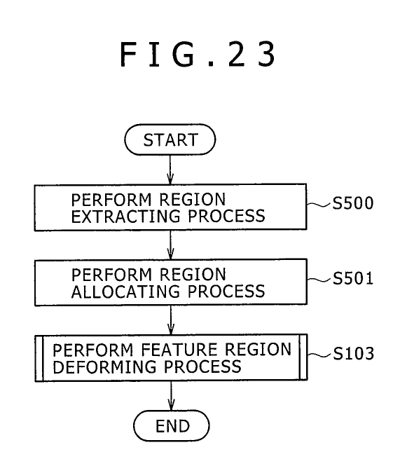

A series of image processes performed by the fifth embodiment will now be described by referring to FIGS. 23 through 25B. The paragraphs that follow will discuss in detail the major differences in terms of image processing between the first and the fifth embodiments. The remaining aspects of the processing are substantially the same between the two embodiments and thus will not be described further.

As shown in FIG. 23, a major difference in image processing between the first and the fifth embodiments is that the fifth embodiment involves initially carrying out a region extracting process (S500), which was not dealt with by the first embodiment explained above with reference to FIG. 4. FIG. 23 is a flowchart of steps outlining typical image processes performed by the fifth embodiment.

During the region extracting process (S500), the fifth embodiment executes the facial region extracting process (S201), character region extracting process (S203), and feature region extracting process (S101), in that order, on the original image in each frame, as described in connection with the image processing by the fourth embodiment.

More specifically, the region extracting process (S500) involves first carrying out the facial region extracting process (S201) on the original image in a given frame. If no facial region is extracted, the character region extracting process (S203) is performed on the same frame. If no character region is extracted, then the feature region extracting process (S101) is carried out on the same frame.

Even if a feature region such as a facial region, a character region, etc., is extracted in the corresponding extracting process (S101, S201, S203) during the region extracting process (S500), the subsequent extracting process or processes may still be carried out. It follows that if the original image in any one frame contains a plurality of feature regions and/or character regions, etc., all these regions can be extracted.

Although the region extracting process (S500) of the fifth embodiment was shown executing the facial region extracting process (S201), character region extracting process (S203), and feature region extracting process (S101), in that order, this is only an example and is not limitative of the present invention. Alternatively, the processes may be sequenced otherwise.

As another alternative, the region extracting process (S500) of the fifth embodiment need not carry out all of the facial region extracting process (S201), character region extracting process (S203), and feature region extracting process (S101). It is possible to perform at least one of the three extracting processes.

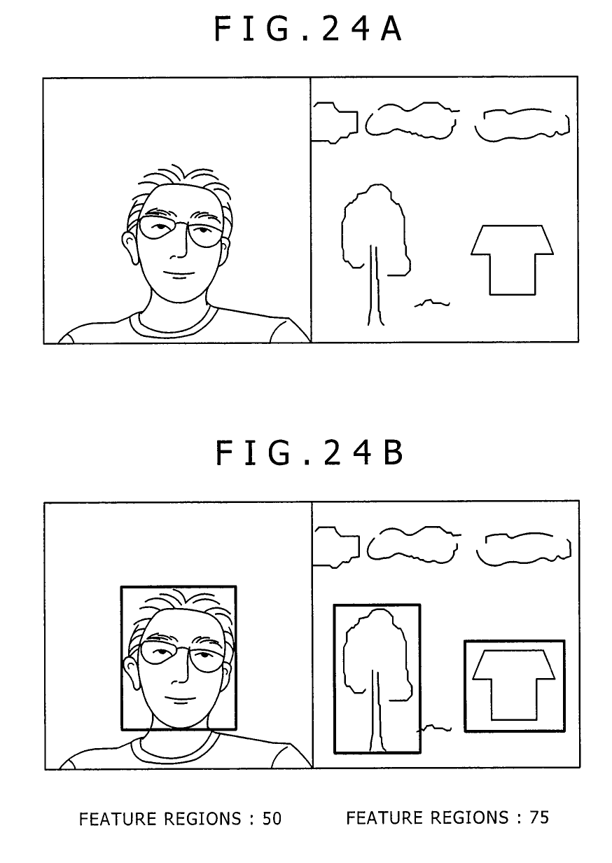

In the case of a typical original image group in two frames shown in FIG. 24A, executing the region extracting process (S500) causes the facial region extracting process (S201) to extract a facial region from the original image in the left-hand side frame and the feature region extracting process (S101) to extract feature regions from the original image in the right-hand side frame.

As indicated in FIG. 24B, the feature region calculating element 209 calculates the sizes of the extracted feature regions (including facial and character regions), and outputs the feature region sizes to the image positioning element 205. Although the feature region size of the left-hand side frame is indicated as 50 (pixels) and that of the right-hand side frame as 75 (pixels), this is only an example and should not be considered limiting.

As shown in FIG. 23, the extracting process (S500), when completed on each of the frames involved, is followed by a region allocating process (S501).

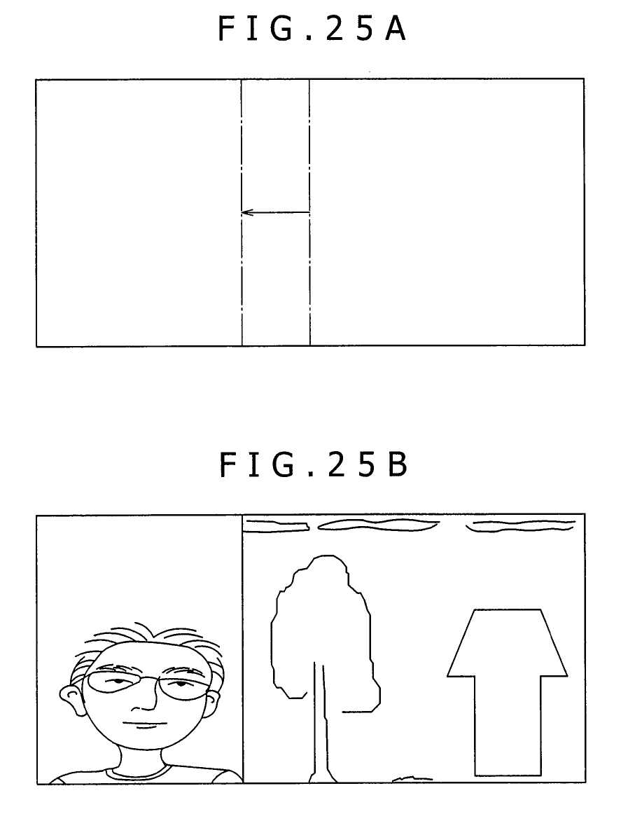

In this process, the image positioning element 205 acquires the sizes of the extracted feature regions from the feature region calculating element 209, compares the acquired sizes numerically, and scales up or down the corresponding frames in proportion to the sizes, as depicted in FIG. 25A.

Illustratively, since the feature region size of the left-hand side frame is 50 and that of the right-hand side frame is 75, the image positioning element 205 scales up (i.e., moves) the right-hand side frame in the arrowed direction and scales down the left-hand side frame by the corresponding amount, as illustrated in FIG. 25A.

The amount by which the image positioning element 205 scales up or down frames is determined by the compared sizes of the feature regions in these frames. The scaling factors for such enlargement and contraction may be set for any values as long as the individual frames of the original images are contained within the framework of the original image group.

After the frames involved are scaled up and down by the image positioning element 205, the region allocating process (S105) as a whole comes to an end. The original images whose frames have been scaled up or down are combined in pixels into a single display image by the pixel combining element 207.

As shown in FIG. 23, the feature region deforming process (S103) is carried out on the original images in the frames that have been scaled up or down. The original images are deformed into a feature-deformed image group indicated in FIG. 25B.

In the series of image processes carried out by the fifth embodiment, the region extracting process (S501), feature region deforming process (S103), and other processes are performed on the basis of mesh data as in the case of the above-described first embodiment.

The foregoing has been the discussion of the series of processes carried out by the fifth embodiment of the present invention. The image processing implemented by the fifth embodiment offers the following major benefits:

(1) A plurality of feature-deformed images are displayed at a time on the screen, which allows the user to recognize the multiple images simultaneously. Because the sizes of frames are varied depending on the sizes of the feature regions detected therein, any feature-deformed image with a relatively larger feature region size than the other images is shown more conspicuously. The image processing apparatus 101 thus helps the user avoid recognizing the desired image erroneously while making searches through images. That means the image processing apparatus 101 is appreciably less likely to receive instructions from the user to select mistaken images.

Although the image processing of the fifth embodiment was shown dealing with original images in two frames as shown in FIGS. 24A through 25B, this is not limitative of the present invention. Alternatively, an original image group of any number of frames may be handled.

### SIXTH EMBODIMENT

An image processing apparatus practiced as the sixth embodiment will now be described. The paragraphs that follow will discuss in detail the major differences between the first and the sixth embodiments. The remaining features of the sixth embodiment are substantially the same as those of the first embodiment and thus will not be described further.

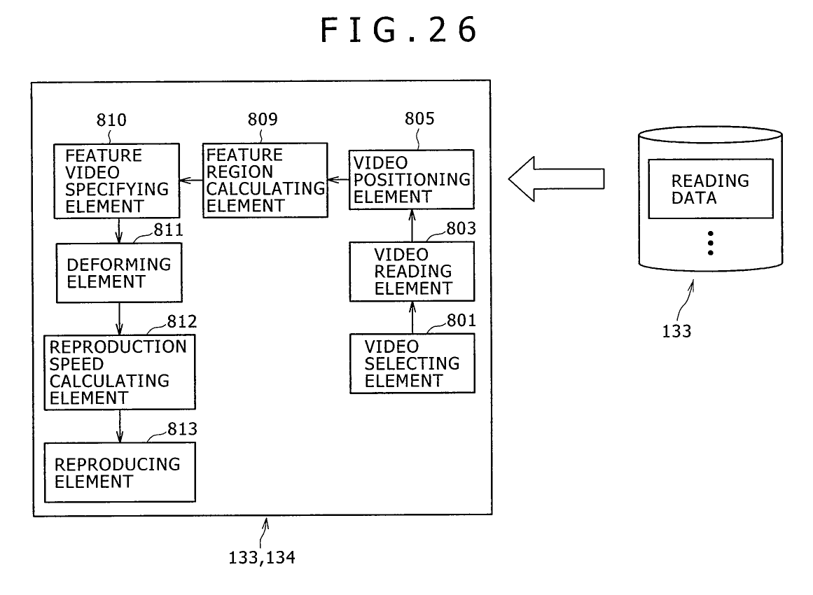

The image processing apparatus 101 practiced as the sixth embodiment of the present invention is compared with the image processing apparatus 101 of the first embodiment in reference to FIGS. 3 and 26. The comparison reveals a major difference: that the image processing apparatus 101 of the first embodiment handles still image data whereas the image processing apparatus of the sixth embodiment deals with video data (i.e., video stream).

In the description that follows, videos are assumed to be composed of moving images only or of both moving images and audio data. However, this is only an example and is not limitative of the invention.

Comparing FIG. 26 with FIG. 3 reveals another difference: that as opposed to its counterpart of the first embodiment, the program held in the storage unit 133 or RAM 134 of the sixth embodiment includes a video selecting element 801, a video reading element 803, a video positioning element 805, a feature region calculating element 809, a feature video specifying element 810, a deforming element 811, a reproduction speed calculating element 812, and a reproducing element 813.

The computer program for implementing the sixth embodiment is assumed to be preinstalled. However, this is only an example and is not limitative of the present invention. Alternatively, the computer program may be a program written in Java™ (registered trademark) or the like which is downloaded from a suitable server and interpreted.

As shown in FIG. 26, the video selecting element 801 is a module which, upon receipt of instructions from the input unit 136 operated by the user, selects the video that matches the instructions or moves a cursor across displayed thumbnails each representing the beginning of a video in order to select the desired video.

The video selecting element 801 is not functionally limited to receiving the user's instructions; it may also function to select videos that are stored internally or videos that exist on the network randomly or in reverse chronological order.

The video reading element 803 is a module that reads as video data (i.e., video stream) the video selected by the video selecting element 801 from the storage unit 133 or from servers or other sources on the network. The video reading element 803 is also capable of capturing the first single frame of the retrieved video and processing it into a thumbnail image. With the sixth embodiment, it is assumed that videos include still images such as thumbnails unless otherwise specified.

The video positioning element 805 is a module that positions videos where appropriate on the screen of the display unit 137. The screen displays one or a plurality of videos illustratively at predetermined space intervals. However, this image layout is not limitative of the functionality of the video positioning element 805. Alternatively, the video positioning element 805 may function to let a video be positioned over the entire screen during reproduction.

The feature region calculating element 809 is a program module that acquires an average image of a single frame from the original images of the frames constituted by video data (video stream). The feature region calculating element 809 calculates the difference between the average image and the original image in each frame in order to extract a feature region and to output the size (in numerical value) of the extracted feature region. The average image will be discussed later in detail.

The following paragraphs will describe cases in which a feature region is extracted from the original image of a frame constituted by video data applicable to the sixth embodiment. This, however, is only an example and should not be considered to be limiting. Alternatively, it is possible to obtain feature regions in terms of audio data supplementing video data (e.g., as a deviation from the average audio).

The feature video specifying element 810 is a program module that plots the values of feature regions from the feature region calculating element 809 chronologically one frame at a time. After plotting the feature values of all frames, the feature video specifying element 810 specifies a feature video by establishing a suitable threshold value and acquiring the range of frames whose feature region values are in excess of the established threshold. The feature video specifying process will be discussed later in detail.

As in the case of still images, the feature video specifying element 810 of the sixth embodiment generates mesh data corresponding to a given video stream in which to specify a feature video. Using the mesh data thus generated, the feature video specifying element 810 may grasp the position of the feature video.

The feature video applicable to the sixth embodiment will be shown to be specified on the basis of images. However, this is not limitative of the present invention. Alternatively, it is possible to specify feature videos based on the audio data supplementing the video data.

When the position of a feature video is specified by the feature video specifying element 810, the deforming element 811 acquires parameters representative of the distances of each frame relative to the specified position of the feature video. Using the parameters thus obtained, the deforming element 811 performs its deforming process on the video stream including not only the feature video but also other video portions as well.

The deforming element 811 of the sixth embodiment may illustratively carry out the deforming process on the mesh data generated by the feature region calculating element 809, the deformed mesh data being used to reproduce the video stream. Because the deforming element 811 need not directly deform the video stream, the deforming process can be performed efficiently with a significantly reduced amount of calculations.

The reproduction speed calculating element 812 is a module capable of calculating the reproduction speed of a video stream that has been deformed by the deforming element 811. The reproduction speed calculating process will be discussed later in detail.

The reproducing element 813 is a module that reproduces the video stream in keeping with the reproduction speed acquired by the reproduction speed calculating element 812. The reproducing element 813 may also carry out a decoding process where necessary. That means the reproducing element 813 can reproduce video streams in such formats as MPEG-2 and MPEG-4.

### Average Image

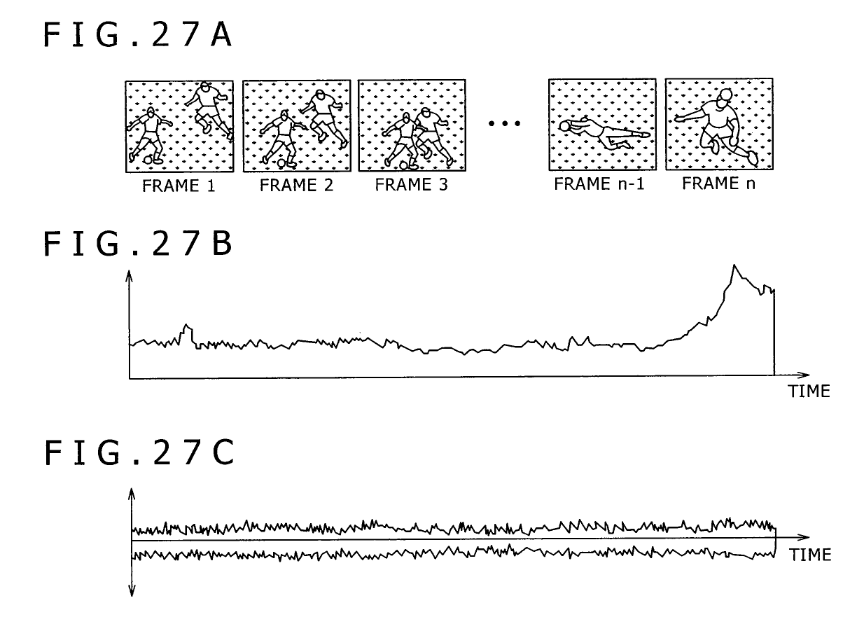

The average image applicable to the sixth embodiment of the present invention will now be described with reference to FIGS. 27A through 28. FIGS. 27A, 27B, and 27C are explanatory views outlining typical structures of images applicable to the sixth embodiment. FIG. 28 is an explanatory view outlining a typical structure of a representative average image applicable to the sixth embodiment.

As shown in FIG. 27A, the video stream applicable to the sixth embodiment is constituted by the original images in as many as “n” frames (n>1) corresponding to a given reproduction time. The sequence of frame 1 through frame “n” is the order in which the corresponding original images are to be reproduced. The frames may be sequenced differently when encoded. That means the frames to be handled by the sixth embodiment may accommodate B pictures or the like in such formats as MPEG-2 and MPEG-4.

The frames shown in FIG. 27A (frame 1 through frame n) are accompanied by audio data (e.g., see FIG. 27C) corresponding to the original image of each frame constituting a video stream. However, this is not limitative of the present invention. Alternatively, the video stream may be constituted solely by the moving images composed of original images in a plurality of frames. As another alternative, the video stream may be constituted by audio data alone.

The video applicable to the sixth embodiment includes a moving image part and an audio part. Meanwhile, as explained above, the feature region calculating element 809 acquires feature regions by detecting the difference between an average image established as reference on the one hand, and the original image in each frame on the other hand. The moving image part of the video is then expressed by a graph as shown in FIG. 27B, in which the horizontal axis represents the reproduction time of the video being output in proportion to the sizes (values) of the acquired feature regions, and the vertical axis denotes the feature region sizes.

The graph of FIG. 27B outlines transitions of feature region sizes in the moving image part relative to the average image. However, this is only an example and is not limitative of the invention. Alternatively, the graph may represent transitions of feature region volumes in the audio part relative to an average audio. The average audio may illustratively be what is obtained by averaging the volume levels in the audio part making up the video stream.

The graph of FIG. 27C shows transitions of volume levels occurring in the video. Illustratively, along the vertical axis of the graph, the upward direction stands for the right-hand side channel audio and the downward direction for the left-hand side channel audio. However, this is only an example and is not limitative of the invention.

A graph in the upper part of FIG. 28 is identical to what is shown in FIG. 27B. As indicated in FIG. 28, an average image 750 is created by averaging the pixels of all or part of the original images constituting the video in terms of brightness, color (saturation), brightness level (brightness value), or saturation level (saturation value).

Since the genre of the video in this example is soccer, the average image 750 indicated in FIG. 28 has an overall color of green representative of the lawn covering the ground. However, this is not limitative of the invention. Diverse kinds of average images 750 may be created from diverse kinds of videos.

Feature regions are obtained by calculating the difference between the original image of each frame making up the video stream on the one hand, and the average image 750 on the other hand. The process will be discussed later in more detail. The results of the calculations are used to create the graph in FIG. 27B.

As shown in FIG. 28, a feature video 703-1 above a threshold S0 includes frames 701-1 through 701-3 containing original images. These original images are shown to include soccer players while carrying relatively small amounts of colors close to the lawn green taking up a large portion of the average image 750. Given such characteristics, the feature regions are seen slightly above the threshold S₀ when compared with the latter.

A video 703-2, meanwhile, has frames 701-4 through 701-6 containing original images. These original images are shown to include large amounts of colors close to the lawn green in the average image 750. For this reason, the feature regions are seen below the threshold S0 when compared with the latter.

A feature video 703-3, as indicated in FIG. 28, has frames 701-7 through 701-9 containing original images. These original images are seen having few colors close to the lawn green in the average image 750 and carrying many close-ups of soccer players instead. This causes the feature regions to be above the threshold S₀ appreciably upon comparison with the latter.

Although the videos 703-1 through 703-3 in FIG. 28 are shown to have three frames each, this is only an example and is not limitative of the present invention. The video 703 may include original images placed in one or a plurality of frames.

### Average Image Creating Process

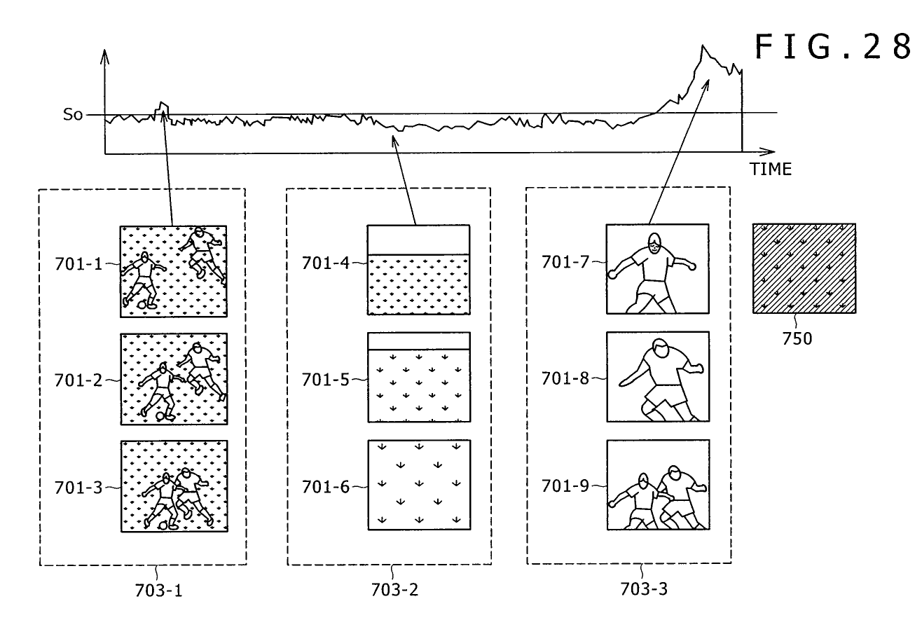

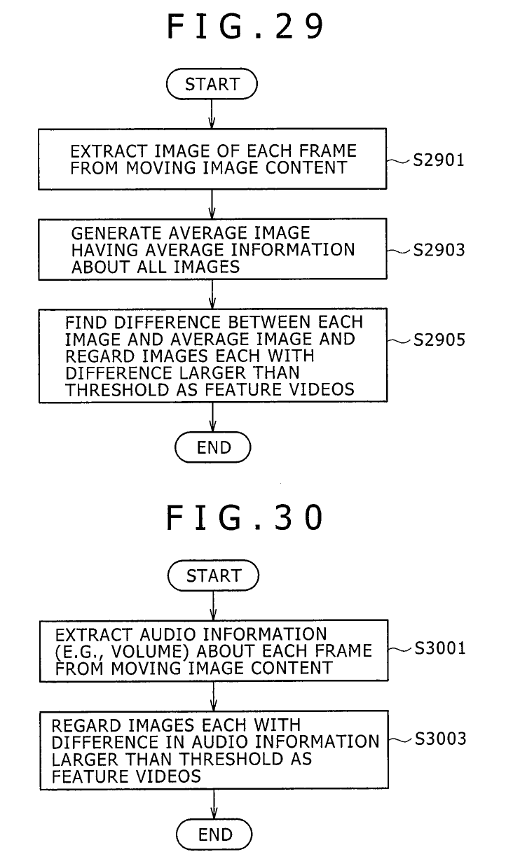

The process for creating the average image for use with the sixth embodiment of the invention will now be described with reference to FIG. 29. FIG. 29 is a flowchart of steps constituting the average image creating process performed by the sixth embodiment.

As shown in FIG. 29, the feature region calculating element 809 first extracts (in step S2901) the image (original image) of each of the frames constituting the moving image content (i.e., video stream). The original images thus extracted are stored temporarily in the storage unit 133, RAM 134, or elsewhere until the average image is created.

After extracting the images (original image) from the frames, the feature region calculating element 809 finds an average of the original image pixels in terms of brightness or saturation (in step S2903), whereby the average image 750 is created. These are the steps for creating the average image 750.

In addition, as mentioned above, the feature region calculating element 809 detects the difference between the original image of each frame constituting the video stream on the one hand, and the average image 750 created as described on the other hand. The detected differences are regarded as feature regions and their sizes (in values) are output by the feature region calculating element 809.

The feature video specifying element 810 then acquires the values of the feature regions following output from the feature region calculating element 809. The values, acquired in the order in which the original images are to be reproduced chronologically frame by frame, are plotted to create a graph such as the one shown in FIG. 27B (feature region graph). Supplementing the graph of FIG. 27B with the appropriate threshold S0 creates the feature region graph in FIG. 28.

On the basis of the feature region graph having the threshold S0 established therein, the feature video specifying element 810 determines (in step S2905) that the images having feature region values higher than the threshold S0 are feature videos.

Described below with reference to FIG. 30 is a variation of the average image creating process applicable to the sixth embodiment. FIG. 30 is a flowchart of steps in which the sixth embodiment specifies a feature video based on audio information.

As shown in FIG. 30, the feature region calculating element 809 first extracts (in step S3001) audio information from each of the frames constituting a moving image content (i.e., video stream).

The feature region calculating element 809 outputs values representative of the extracted audio information about each frame.

The feature video specifying element 810 then acquires the values of the audio information following output from the feature region calculating element 809. The values, acquired in the order in which the original images are to be reproduced chronologically frame by frame, are plotted to create a graph such as the one shown in FIG. 27C (audio information graph). The graph of FIG. 27C is supplemented with an appropriate threshold S1, not shown.

On the basis of the audio information graph having the threshold S1 established therein, the feature video specifying element 810 determines (in step S3003) that the images having audio information values higher than the threshold S1 are feature videos.

The audio information applicable to the sixth embodiment may illustratively be defined as loudness (i.e., volume). However, this is only an example and should not be considered limiting. Alternatively, audio information may be defined as pitch.

### Deforming Process

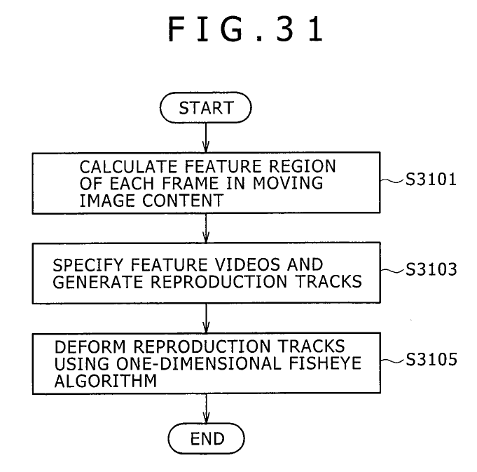

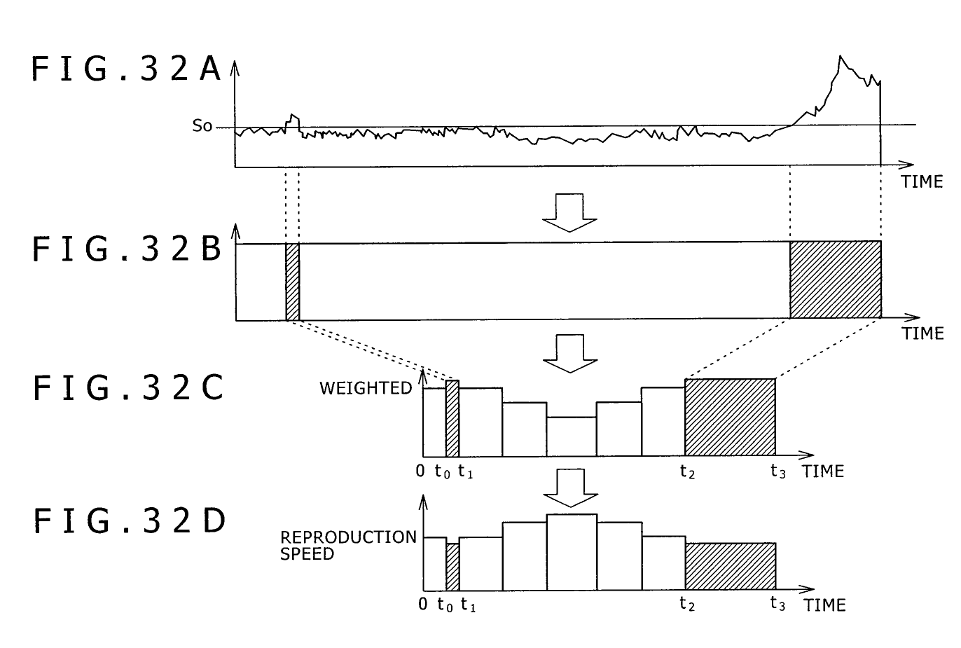

The deforming process performed by the sixth embodiment of the invention will now be described by referring to FIGS. 31 through 32D. FIG. 31 is a flowchart of steps constituting a representative deforming process carried out by the sixth embodiment. FIGS. 32A, 32B, 32C, and 32D are explanatory views showing how the sixth embodiment typically performs its deforming process.

As shown in FIG. 31, the feature region calculating element 809 first calculates (in step S3101) the feature region of each of the frames constituting a moving image content (i.e., video stream). The feature region values calculated by the feature region calculating element 809 are output to the feature video specifying element 810.

The feature video specifying element 810 plots the feature region values output by the feature region calculating element 809 so as to create a feature region graph as illustrated in FIG. 32A. The created graph is supplemented with a suitable threshold S0.

The feature video specifying element 810 then specifies feature videos (in step S3103) in order to create reproduction tracks (or video stream, mesh data), as indicated in FIGS. 31 and 32B.

The feature videos are shown hatched in FIG. 32B. The reproduction tracks are videos over a given time period each. Illustratively, the feature videos are left intact while the other video portions are divided into a plurality of reproduction tracks at intervals of three minutes. However, this is only an example and should not be considered limiting.

FIGS. 32B and 32C indicate the presence of eight reproduction tracks including the feature videos. Alternatively, one or a plurality of reproduction tracks may be created.

As shown in FIG. 32B, after the reproduction tracks are created by the feature video specifying element 810 (in step S3103), the deforming element 811 acquires as parameters the distances of each of the reproduction tracks relative to the feature videos and, based on the acquired parameters, deforms each reproduction track using a one-dimensional fisheye algorithm (in step S3105).

The reproduction tracks are shown to be the videos of given time periods constituting the video stream. However, this is only an example and should not be considered limiting. Alternatively, the reproduction tracks may be constituted by mesh data corresponding to the video stream.

FIG. 32C shows the reproduction tracks as they are deformed by use of the one-dimensional fisheye algorithm. It can be seen that the feature videos (reproduction tracks) remain unchanged in height along the vertical axis while the other reproduction tracks are shorter along the vertical axis as farther away from the feature videos.

The one-dimensional fisheye deforming process performed by the deforming element 811 is substantially the same as the process carried out by the fisheye algorithm discussed earlier and thus will not be described further. However, the deforming process is not limited by the fisheye algorithm alone; the process may adopt any other suitable deforming technique.

The horizontal axis in each of FIGS. 32A, 32B, and 32C is shown to denote reproduction time. However, this is not limitative of the present invention. Alternatively, the horizontal axis may represent frames or their numbers which constitute the moving image content (video stream) and which are arranged in the order of reproduction.

The closeness of each reproduction track relative to the feature videos is obtained illustratively in terms of distances between a point in time t0, t1, or t2 shown in FIG. 32C on the one hand, and the reproduction track of interest on the other hand. Of the distances thus acquired, the longest may be used as the parameter for use in deforming the reproduction track in question. However, this is only an example and should not be considered limitating of the invention.

After the reproduction tracks are deformed by the deforming element 811 (in step S3105), the reproduction speed calculating element 812 acquires weighting values from the deformed reproduction tracks shown in FIG. 32C and finds the inverse of the acquired values to calculate reproduction speeds. The calculated reproduction speeds of the reproduction tracks are indicated in FIG. 32D.

As shown in FIG. 32C, the heights along the vertical axis of the reproduction tracks in the moving image content (video stream) represent the weighting values for use in calculating reproduction speeds. The reproduction speed calculating element 812 acquires these weighting values for the reproduction tracks when calculating the reproduction speeds of the latter.

After obtaining the values (weighting values) of the reproduction tracks along the vertical axis, the reproduction speed calculating element 812 regards the reproduction speed of the feature videos (reproduction tracks) as a normal speed (reference speed) and acquires the inverse numbers of the acquired weighting values. The reproduction speeds of the reproduction tracks are obtained in this manner, whereby a reproduction speed graph such as one shown in FIG. 32D is created.

As indicated in FIGS. 32C and 32D, the reproduction tracks of the feature videos range from the time to t₀ the time t₁ and from the time t₂ to a time t₃. These two feature videos are reproduced at the normal reproduction speed.

After the reproduction speeds are calculated by the reproduction speed calculating element 812, the reproducing element 813 reproduces the video stream in accordance with the reproduction speeds indicated in FIG. 32D.

It can be seen in FIG. 32D that the closer the video portion (reproduction track) of interest to the feature videos, the closer the reproduction speed of that video portion to the normal speed; and that the farther away from the feature videos, the progressively higher the reproduction speed of the video portion (reproduction track) than the normal speed (especially in the central part of FIG. 32D).

As a result, the feature videos and the reproduction tracks (frame groups) nearby are reproduced slowly, i.e., at about the normal reproduction speed when output onto the display unit 137. This allows the viewer to grasp the feature videos and their nearby portions more reliably than the remaining portions. The video portions other than the feature videos are reproduced at higher speeds but not skipped. The viewer is thus able to get a quick yet unfailing understanding of the entire video stream.

The reproducing element 813 may, in interlocked relation to the reproduction speeds shown in FIG. 32D, illustratively raise the volume while the feature videos are being reproduced. The higher the reproduction speed of the other video portions, the lower the volume that may be set by the reproducing element 813 during reproduction of these portions.

Illustratively, the series of video processing performed by the sixth embodiment may involve dealing with a plurality of videos individually or in parallel on the screen of the image processing apparatus 101 as shown in FIG. 1.

The series of image processing described above may be executed either by dedicated hardware or by software. For the software-based image processing to take place, the programs constituting the software are installed into an information processing apparatus such as a general-purpose personal computer or a microcomputer. The installed programs then cause the information processing apparatus to function as the above-described image processing apparatus 101.

The programs may be installed in advance in the storage unit 133 (e.g., hard disk drive) or ROM 132 acting as a storage medium inside the computer.

The programs may be stored (i.e., recorded) temporarily or permanently not only on the hard disk drive but also on such a removable storage medium 111 as a flexible disk, a CD-ROM (Compact Disc Read-Only Memory), an MO (Magneto-Optical) disk, a DVD (Digital Versatile Disc), a magnetic disk, or a semiconductor memory. The removable storage medium may be offered to the user as so-called package software.

The programs may be not only installed into the computer from the removable storage medium as described above, but also transferred to the computer either wirelessly from a download website via digital satellite broadcasting networks or in wired fashion over such networks as LANs (Local Area Networks) or the Internet. The computer may receive the transferred programs through the communication unit 139 and have them installed into the internal storage unit 133.

In this specification, the processing steps which describe the programs for causing the computer to perform diverse operations may not be carried out in the depicted sequence in the flowcharts (i.e., in chronological order); the steps may also include processes that are conducted parallelly or individually (e.g., in parallel or object-oriented fashion).

The programs may be processed either by a single computer or by a plurality of computers in distributed fashion.

Although the above-described embodiments were shown to deform original images by executing the deforming process on the mesh data corresponding to these images, this should not be considered limiting. Alternatively, an embodiment may carry out the deforming process directly on original images.

Whereas the image processing apparatus 101 was shown having its functional elements composed of software, this is only an example and not limitative of the invention. Alternatively, each of these functional elements may be constituted by one or a plurality of pieces of hardware such as devices or circuits.

It is to be understood that while the invention has been described in conjunction with specific embodiments with reference to the accompanying drawings, it is evident that many alternatives, modifications, and variations will become apparent to those skilled in the art in light of the foregoing description. Accordingly, it is intended that the present invention embrace all such alternatives, modifications, and variations as fall within the spirit and scope of the appended claims.

The invention is claimed as follows:

1. An image processing apparatus comprising:
an extracting device configured to extract feature regions from image regions of original images constituted by at least one frame; and
an image deforming device configured to deform said original images with regard to said feature regions to create feature-deformed images.

2. The image processing apparatus according to claim 1, wherein said image deforming device deforms original image portions corresponding to the image regions other than said feature regions in said image regions of said original images, said image deforming device further scaling original image portions corresponding to said feature regions.

3. The image processing apparatus according to claim 2, wherein a scaling factor for use in scaling said original images varies with sizes of said feature regions.

4. The image processing apparatus according to claim 1, wherein said image deforming device generates mesh data based on said original images, deforms the portions of said mesh data which correspond to the image regions other than said feature regions in said image regions of said original images, and scales the portions of said mesh data which correspond to said feature regions.

5. The image processing apparatus according to claim 1, further comprising a size changing device configured to change sizes of the frames of each of said original images, in keeping with sizes of the feature regions extracted from original images constituted by a plurality of frames.

6. The image processing apparatus according to claim 1, further comprising:
an input device configured to input instructions from a user for initiating said extracting device and said image deforming device; and
an output device configured to output said feature-deformed images.

7. The image processing apparatus according to claim 1, wherein said feature regions include either facial regions of an imaged object or character regions.

8. An image processing method comprising:
extracting feature regions from image regions of original images constituted by at least one frame; and
deforming said original images with regard to said feature regions so as to create feature-deformed images.

9. The image processing method according to claim 8, which includes deforming original image portions corresponding to image regions other than said feature regions in said image regions of said original images, wherein said image deforming includes scaling original image portions corresponding to said feature regions.

10. The image processing method according to claim 9, wherein a scaling factor for use in scaling said original images varies with sizes of said feature regions.

11. The image processing method according to claim 8, wherein said image deforming step generates mesh data based on said original images and deforms said mesh data.

12. The image processing apparatus according to claim 8, further comprising:
changing sizes of the frames of each of said original images, in keeping with sizes of the feature regions extracted from original images constituted by a plurality of frames;
wherein said extracting step and said image deforming step are carried out on the image regions of said original images following the change in the frame sizes of said original images.

13. The image processing method according to claim 8, further comprising:
input instructions from a user for starting said extracting step and said image deforming step; and
output said feature-deformed images after the starting instructions have been input and said extracting process and said image deforming step have ended.

14. A computer program for causing a computer to function as an image processing apparatus comprising:
extracting means for extracting feature regions from image regions of original images constituted by at least one frame; and
image deforming means for deforming said original images with regard to said feature regions so as to create feature-deformed images.

15. The computer program according to claim 14, wherein said image deforming means deforms original image portions corresponding to the image regions other than said feature regions in said image regions of said original images, said image deforming means further scaling original image portions corresponding to said feature regions.

16. An image processing apparatus for reproducing a video stream carrying a series of original images constituted by at least one frame, said image processing apparatus comprising:
an extracting device configured to extract feature regions from image regions of said original images constituting said video stream;
a feature video specifying device configured to specify as a feature video the extracted feature regions larger in size than a predetermined threshold;
a deforming device configured to deform said video stream based at least on parameters each representing a distance from said feature video to said frame of each of said original images, said deforming device further acquiring weighting values on the basis of the deformed video stream; and
a reproduction speed calculating device configured to calculate a reproduction speed based on the weighting values acquired by said deforming device.

17. The image processing apparatus according to claim 16, further comprising a reproducing device configured to reproduce said video stream in accordance with said reproduction speed acquired by said reproduction speed calculating device.

18. The image processing apparatus according to claim 16, wherein the reproduction speed for stream portions other than said feature video is increased as the distance increases from said feature video being reproduced at a reference velocity of said reproduction speed.

19. The image processing apparatus according to claim 16, wherein said extracting device extracts said feature regions from said image regions of said original images by determining differences between each of said original images and an average image generated from either part or all of the frames constituting said video stream.

20. The image processing apparatus according to claim 19, wherein said average image is created on the basis of levels of brightness and/or of color saturation of pixels in either part or all of said frames constituting said original images.

21. The image processing apparatus according to claim 16, wherein the volume for stream portions other than said feature video is decreased as the distance increases from said feature video being reproduced at a reference volume.

22. The image processing apparatus according to claim 16, wherein said extracting device extracts as feature regions audio information representative of the frames constituting said video stream; and
wherein said feature video specifying device specifies as said feature video the frames which are extracted when found to have audio information exceeding a predetermined threshold of said audio information.

23. A reproducing method for reproducing a video stream carrying a series of original images constituted by at least one frame, said reproducing method comprising:
extracting feature regions from image regions of said original images constituting said video stream;
specifying as a feature video the extracted feature regions larger in size than a predetermined threshold;
deforming said video stream based at least on parameters each representing a distance from said feature video to said frame of each of said original images, said deforming device further acquiring weighting values on the basis of the deformed video stream; and
calculating a reproduction speed based on the weighting values acquired in said deforming step.

24. A computer program for causing a computer to function as an image processing apparatus for reproducing a video stream carrying a series of original images constituted by at least one frame, said image processing apparatus comprising:
extracting means for extracting feature regions from image regions of said original images constituting said video stream;
feature video specifying means for specifying as a feature video the extracted feature regions larger in size than a predetermined threshold;
deforming means for deforming said video stream based at least on parameters each representing a distance from said feature video to said frame of each of said original images, said deforming means further configured to acquire weighting values on the basis of the deformed video stream; and
reproduction speed calculating means for calculating a reproduction speed based on the weighting values acquired by said deforming means.
